(19) United States
(12) Patent Application Publication
(10) Pub. No.: US 2005/0185672 A1
(43) Pub. Date: Aug. 25, 2005

(54) IPv6/IPv4 translator

(75) Inventors: Masahito Endo, Tokyo (JP); Hiroshi Miyata, Tokyo (JP); Nobumichi Ozoe, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/056,124

(22) Filed: Feb. 14, 2005

(30) Foreign Application Priority Data
Feb. 23, 2004 (JP) 2004-045695

(51) Int. Cl. H04L 12/28; H04L 12/56

(52) U.S. Cl. 370/466; 370/401

(57) ABSTRACT

An object of the present invention is to realize packet communication between an IPv6 terminal connected to an IPv6 network and an IPv4 terminal connected to an IPv4 network. Another object of the present invention is to realize RTP communication for establishing sessions in accordance with SIP between an IPv6 terminal connected to an IPv6 network and an IPv4 terminal connected to an IPv4 network. For these objects, the present invention provides an IPv6/IPv4 translator for translating packets between IPv6 and IPv4 with means of translating addresses described in SIP messages into IPv6 addresses or IPv4 addresses. Moreover, the present invention provides the aforementioned IPv6/IPv4 translator with means of translating addresses described in SDP messages into IPv6 addresses or IPv4 addresses. These SDP messages shall be related to media data transmissions. Furthermore, the IPv6/IPv4 translator can be directly connected to a terminal connected to an IPv6 network and to a terminal connected to an IPv4 network, or can be connected via SIP proxy to an SIP terminal connected to an IPv6 network and to an SIP terminal connected to an IPv4 network. According to the present invention, the IPv6/IPv4 translator translates addresses described in SIP messages into IPv6 addresses or IPv4 addresses when translating packets from IPv6 to IPv4 or from IPv4 to IPv6. Therefore, it will be possible to perform communication from a terminal supporting IPv6 only to a terminal supporting IPv4 only. Also, it will be possible to perform communication from a terminal supporting IPv4 only to a terminal supporting IPv6 only. In addition, the IPv6/IPv4 translator translates addresses described in SDP messages into IPv6 addresses or IPv4 addresses when translating packets from IPv6 to IPv4 or from IPv4 to IPv6. Therefore, it will be possible to perform RTP communication for establishing sessions in accordance with SIP from IPv6 to IPv4 or conversely from IPv4 to IPv6, which is suitable for media data transmissions such as IP phone services.

### BACKGROUND OF THE INVENTION

1. Field of the Invention

The present invention relates to an IPv6/IPv4 translator, and more specifically, to an IPv6/IPv4 translator which translates packets based on SIP (Session Initiation Protocol) from IPv6 to IPv4 or from IPv4 to IPv6 or which translates media data based on RTP (Realtime Transport Protocol).

2. Description of the Related Art

Paragraph 0049 of Patent Document 1 contains descriptions on header translations between IPv6 and IPv4.

However, Patent Document 1 relates to packet processing apparatuses, packet processing methods, and packet switching devices. It realizes reduction of memory as well as smooth pipeline processing without contention in access to shared memory between different layer processing. On the other hand, the present invention enables communication between terminals which support different protocols only and its objects are different from those of Patent Document 1.

[Patent Document 1]

Japanese Unexamined Patent Application Publication No. 2000-115234 Recently, as the various providers start IP phone services, IP phones are starting to become more widely used by general users. A global address is required to use an IP phone.

However, since there is a problem with a shortage of IPv4 addresses, it will be difficult to accommodate all users with the present IPv4-based services. Using the IPv6 can be seen as a solution to this problem. In addition, it is conceivable that, due to issues such as resources and so on, terminals supporting only the IPv6 will be developed in the future. However, terminals supporting only the IPv6 will not be able to communicate with existing terminals which support only the IPv4.

This situation where terminals supporting different protocols only are not able to communicate with each other is undesirable because user convenience would be substantially impaired.

Thus, a mechanism using an IPv6/IPv4 translator will be required to enable communication between terminals supporting different protocols only. FIG. 1 is a conceptual block diagram wherein a terminal UA (User Agent) 1 and a terminal UA2 communicate via SIP Proxy1 and SIP Proxy2, which are based on the SIP. Here, UA1 and UA2 are preset to be able to use SIP Proxy 1 and SIP Proxy 2.

The addresses of UA1, UA2, SIP Proxy1, and SIP Proxy2 in FIG. 1 are set as follows:
UA1: 10.0.1.1
UA2: 10.0.3.1
Proxy1: 10.0.1.2/10.0.2.2
Proxy2: 10.0.2.3/10.0.3.3

FIG. 2 shows an example of SIP messages which UA1 and UA2 use for communication. Only the necessary sections of the SIP message are described in FIG. 2. The italicized section shows the SDP message. “src” and “dst” that follow a number represent the source address and the destination address of the relevant packet respectively. Fields of the message shown in FIG. 2 are explained:

<Request Line>

This is the first line of the SIP message that includes a method, Request-URI, etc. The method represents a request type and includes INVITE, BYE, ACK, etc. URI according to the role of the method is in Request-URI. In the case of INVITE, for example, Request-URI showing the destination of the request is entered.

<Via Field>

A location (address) which the message goes through is entered.

<Record-Route Field>

This field is used if a call control is performed by way of a specific SIP Proxy server. The field is inserted by the SIP Proxy.

<Route Field>

This field is used for performing a call control by way of a specific SIP Proxy server. The SIP Proxy server which a message must go through is designated in the request message.

<Contact Field>

A contact party of a terminal UA that sent a request is entered.

<c (Connection Information) Field>

Connection information is entered in this field and includes a destination address to which session data is sent.

<m (Media Description, Name and Address) Field>

This field includes a media type, a destination port number to which session data is sent, etc.

FIG. 3 is a conceptual example diagram for communication from a terminal UA1 “alice” to a terminal UA2 “bob”, both of which support the same protocol (IPv4). FIG. 4 to 6 are operational diagrams of FIG. 3.
1) UA1 sends an INVITE message to UA2. The destination address of this packet is the address of SIP Proxy1.
2) SIP Proxy1 which received packet 1) adds its own address to the Via field and the Record-Route field, and forwards the packet to SIP Proxy2. The destination address of this packet is the address of SIP Proxy2.
3) SIP Proxy2 which received packet 2) adds its own address to the Via field and the Record-Route field, and forwards the packet to UA2.
4) After receiving packet 3), UA2 sends a 180 Ringing message. The destination address of this packet is the address of SIP Proxy2.
5) After receiving packet 4), SIP Proxy2 deletes the Via field that SIP Proxy2 itself added, and forwards the packet to SIP Proxy1.
6) SIP Proxy1 which received packet 5) deletes the Via field that SIP Proxy1 itself added, and forwards the packet to UA1.
7) When communication is enabled in UA2 (in the case of a telephone, when its receiver is picked up) , a “200 OK” message is sent to UA1. The destination address of this packet is the address of SIP Proxy 2.
8) SIP Proxy2 deletes the Via field, which SIP Proxy2 itself added, from packet 7), and forwards the packet to SIP Proxy1.
9) After receiving packet 8), SIP Proxy1 deletes the Via field that SIP Proxy1 itself added, and forwards the message to UA1.
10) UA1 sends an ACK message to UA2. The destination address of this packet is the address of Proxy1.
11) SIP Proxy1 deletes its own Route field from packet 10), adds its own address to the Via field, and forwards the packet to SIP Proxy2.
12) SIP Proxy2 deletes its own Route field from packet 11), adds its own address to the Via field, and forwards the packet to UA2.
13) RTP communication starts between UA1 and UA2. Information such as respective destinations, port numbers, and so forth is then determined on the basis of the Connection Information field (c) and the Media Description, name and address field (m) of the messages exchanged in packets 1) to 3) and 7) to 9).
14) UA1 sends a BYE message to UA2. The destination address of this packet is the address of SIP Proxy1.
15) SIP Proxy1 deletes its own Route field from packet 14), adds its own address to the Via field, and forwards the packet to SIP Proxy2.
16) SIP Proxy2 deletes its own Route field from packet 15), adds its own address to the Via field, and forwards the packet to UA2.
17) UA2 sends a “200 OK” message to UA1. The destination address of this packet is the address of SIP Proxy2.
18) After receiving packet 17), SIP Proxy2 deletes the Via field that SIP Proxy2 itself added, and forwards the packet to SIP Proxy1.
19) SIP Proxy1 deletes the Via field, which SIP Proxy1 itself added, from packet 18), and forwards the packet to UA1.

FIG. 7 shows that a terminal UA1 “alice” is connected to an IPv6 network, that a terminal UA2 “bob” is connected to an IPv4 network, and that an IPv6/IPv4 translator is not connected between these networks.

FIG. 8 shows that UA1 attempts to send an SIP message to UA2 in this configuration. However, UA1 cannot send the message to UA2, because UA1 is an IPv6-based terminal while UA2 is an IPv4-based terminal, and these terminals support different protocols.

As shown in FIG. 9, therefore, the use of an IPv6/IPv4 translator is conceivable in order to enable translations between these protocols, wherein the address of UA1 is 3ffe::1, while the address of UA2 is 10.0.0.1.

FIG. 10 is an operational diagram, wherein UA1 performs SIP communication toward UA2 in FIG. 9.
1) UA1, which is connected to an IPv6 network, sends an INVITE message (IPv6) to UA2 which is connected to an IPv4 network.
2) The Translator translates packet 1) from IPv6 to IPv4. However, the data section (SIP message section) is not changed.
3) UA2 which received packet 2) returns a “200 OK” message (IPv4).
4) The Translator translates packet 3) from IPv4 to IPv6. However, the data section (SIP message section) is not changed.
5) UA1 which received packet 4) attempts to send an ACK message. To send the ACK message, UA1 determines a destination by referring to the Contact field of packet 4). However, UA1 cannot send the ACK message, because an IPv4 address is in the Contact field.

FIG. 11 is an operation flow, wherein UA1 performs SIP communications toward UA2 in FIG. 9.
1) UA2 which is connected to an IPv4 network sends an INVITE message (IPv4) to UA1 which is connected to an IPv6 network.
2) The Translator translates packet 1) from IPv4 to IPv6. However, the data section (SIP message section) is not changed
3) UA1 which received packet 2) returns a “200 OK” message.
4) The Translator translates packet 3) from IPv6 to IPv4. However, the data section (SIP message section) is not changed.
5) UA2 which received packet 4) attempts to send an ACK message. To send the ACK message, UA2 determines a destination by referring to the Contact field of packet 4). However, UA2 cannot send the ACK message, because an IPv6 address is in the Contact field.

An IPv6 terminal and an IPv4 terminal that support different protocols cannot send packets to each other without using an IPv6/IPv4 translator. However, since conventional IPv6/IPv4 translators do not translate SIP messages, these terminals cannot return messages such as ACK for INVITE. In addition, conventional IPv6/IPv4 translators do not translate SDP messages, which are exchanged in SIP packets. Therefore, these terminals cannot perform RTP communication, which is real data communication.

### SUMMARY OF THE INVENTION

The present invention solves these problems. An object of the present invention is to realize packet communications between an IPv6 terminal connected to an IPv6 network and an IPv4 terminal connected to an IPv4 network.

Another object of the present invention is to realize RTP communication for establishing sessions in accordance with the SIP between an IPv6 terminal connected to an IPv6 network and an IPv4 terminal connected to an IPv4 network.

Thus, the present invention provides an IPv6/IPv4 translator for translating packets between IPv6 and IPv4 with means of translating addresses described in SIP messages into IPv6 addresses or IPv4 addresses. Moreover, the present invention provides the aforementioned IPv6/IPv4 translator with means of translating addresses described in SDP messages into IPv6 addresses or IPv4 addresses. These SDP messages shall be related to media data transmissions.

Furthermore, the aforementioned IPv6/IPv4 translator can be connected directly to a terminal connected to an IPv6 network and to a terminal connected to an IPv4 network, or can be connected via SIP proxy to an SIP terminal connected to an IPv6 network and to an SIP terminal connected to an IPv4 network.

According to the present invention, the IPv6/IPv4 translator translates addresses described in SIP messages into IPv6 addresses or IPv4 addresses when translating packets from IPv6 to IPv4 or from IPv4 to IPv6. Therefore, it will be possible to perform communication from a terminal supporting IPv6 only to a terminal supporting IPv4 only. Also, it will be possible to perform communication from a terminal supporting IPv4 only to a terminal supporting IPv6 only.

In addition, the IPv6/IPv4 translator translates addresses described in SDP messages into IPv6 addresses or IPv4 addresses when translating packets from IPv6 to IPv4 or from IPv4 to IPv6. Therefore, it will be possible to perform RTP communication for establishing sessions in accordance with SIP from IPv6 to IPv4 or conversely from IPv4 to IPv6, which is suitable for media data transmissions such as IP phone services. Note that communication between terminals supporting different protocols will not be impeded even if a SIP Proxy exists between these terminals.

### BRIEF DESCRIPTION OF THE DRAWINGS

FIG. 1 is a conceptual block diagram wherein a terminal UA (User Agent)1 and a user agent UA2 perform communication via a terminal Proxy1 and a terminal Proxy2, which are based on the SIP.

FIG.2 shows an example of SIP messages which UA1 and UA2 use for communication in the configuration of FIG. 1.

FIG. 3 is a conceptual example diagram for communication from a terminal UA1 “alice” to a user terminal UA2 “bob”.

FIG. 4 is an operational diagram of FIG. 3.

FIG. 5 is an operational diagram of FIG. 3

FIG. 6 is an operational diagram of FIG. 3

FIG. 7 is a conventional conceptual diagram wherein an IPv6/IPv4 translator is not connected between networks.

FIG. 8 is an operational diagram of FIG. 7.

FIG. 9 is a conventional conceptual block diagram wherein an IPv6/IPv4 translator is connected between networks

FIG. 10 is an operational diagram wherein UA1 performs SIP communication towards UA2 in FIG. 9.

FIG. 11 is an operational diagram wherein UA1 performs SIP communication towards UA2 in FIG. 9

FIG. 12 is a configuration diagram wherein an IPv6/IPv4 translator is connected between SIP Proxy (Proxy1) and SIP Proxy (Proxy2).

FIG. 13 is a configuration diagram wherein an IPv6/IPv4 translator is connected between UA1 and SIP Proxy (Proxy1).

FIG. 14 is a configuration diagram wherein an IPv6/IPv4 translator is connected between SIP Proxy (Proxy2) and UA2.

FIG. 15 is a configuration diagram wherein SIP Proxy is not used.

FIG. 16 is a configuration diagram wherein addresses are provided to the elements of FIG. 12.

FIG. 17 shows an example of SIP messages that UA1 and UA2 use for communication in the configuration of FIG. 16.

FIG. 18 is a conceptual example diagram of communication from a terminal UA1 “alice” to a terminal UA2 “bob”.

FIG. 19 is an operational diagram of FIG. 18.

FIG. 20 is an operational diagram of FIG. 18.

FIG. 21 is an operational diagram of FIG. 18.

FIG. 22 is a conceptual example diagram of communication from a terminal UA2 “bob” to a terminal UA1 “alice”.

FIG. 23 is an operational diagram of FIG. 22.

FIG. 24 is an operational diagram of FIG. 22.

FIG. 25 is an operational diagram of FIG. 22.

FIG. 26 is another configuration diagram wherein addresses are provided to the elements of FIG. 12.

FIG. 27 shows an example of SIP messages which UA1 and UA2 use for communication in the configuration of FIG. 26.

FIG. 28 is a conceptual example diagram of communication from a terminal UA1 “alice” to a terminal UA2 “bob”.

FIG. 29 is an operational diagram of FIG. 28.

FIG. 30 is an operational diagram of FIG. 28.

FIG. 31 is a configuration diagram wherein addresses are provided to the elements of FIG. 15.

FIG. 32 shows an example of SIP messages which UA1 and UA2 use for communication in the configuration of FIG. 31.

FIG. 33 is a conceptual example diagram of communication from a terminal UA1 “alice” to a terminal UA2 “bob”.

FIG. 34 is an operational diagram of FIG. 33.

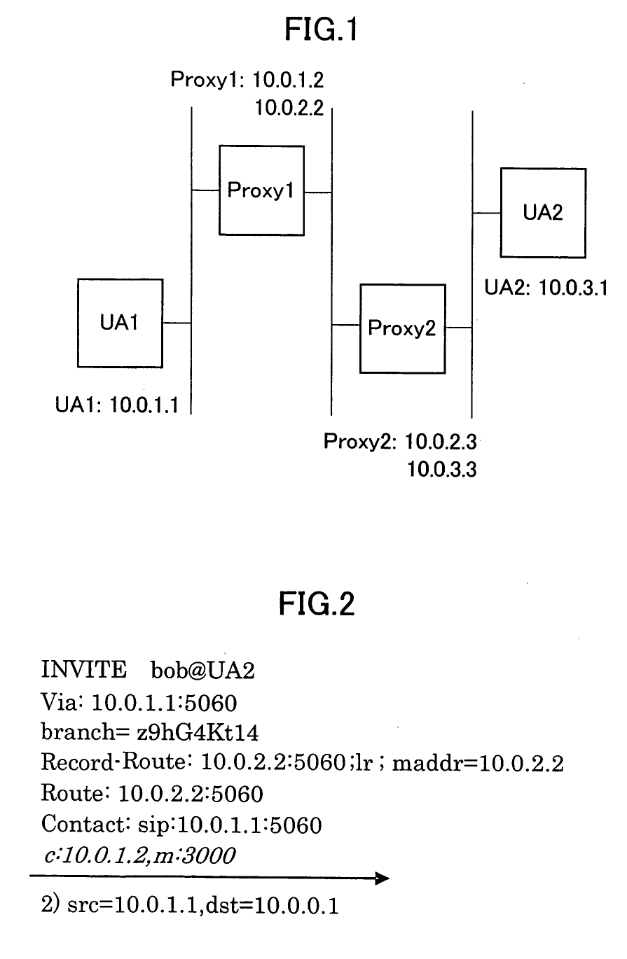

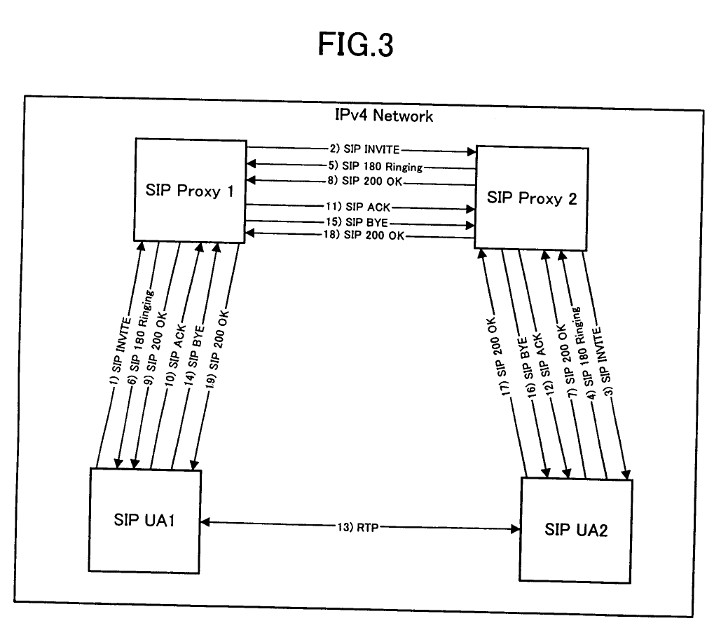

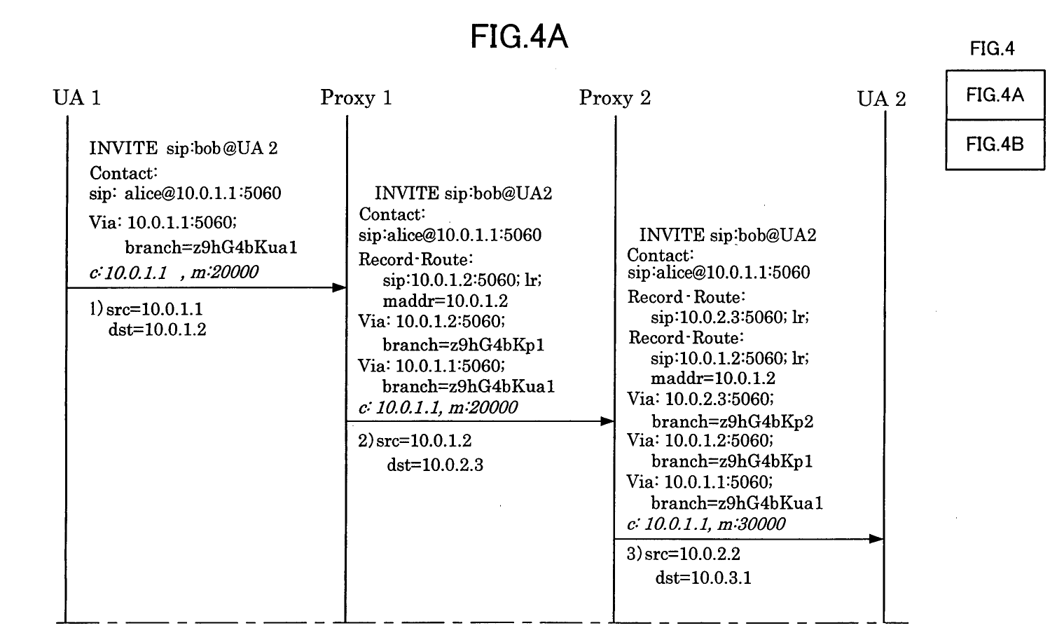

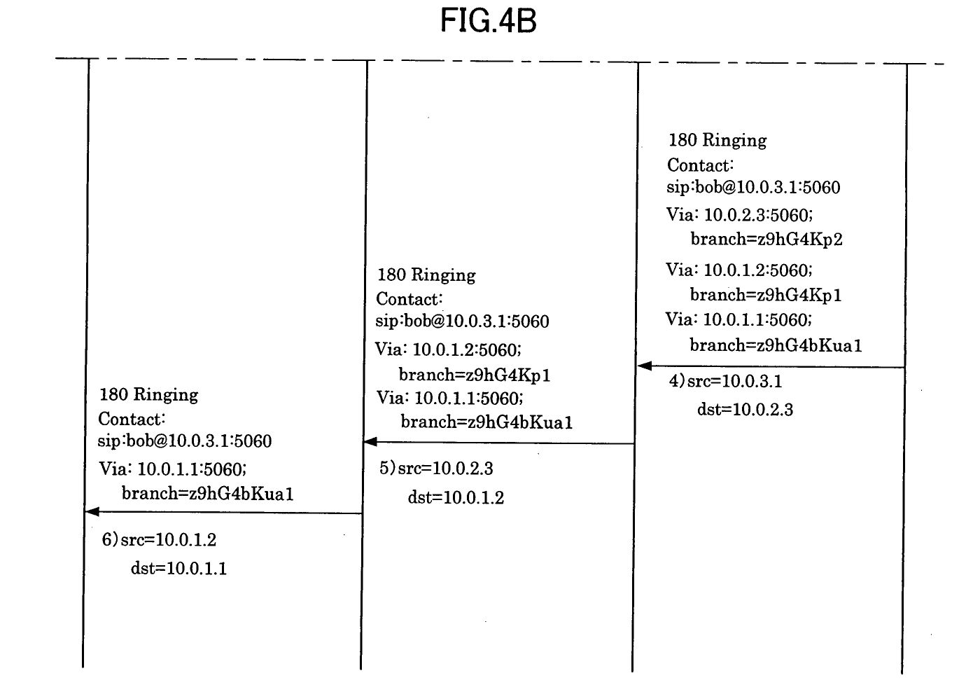

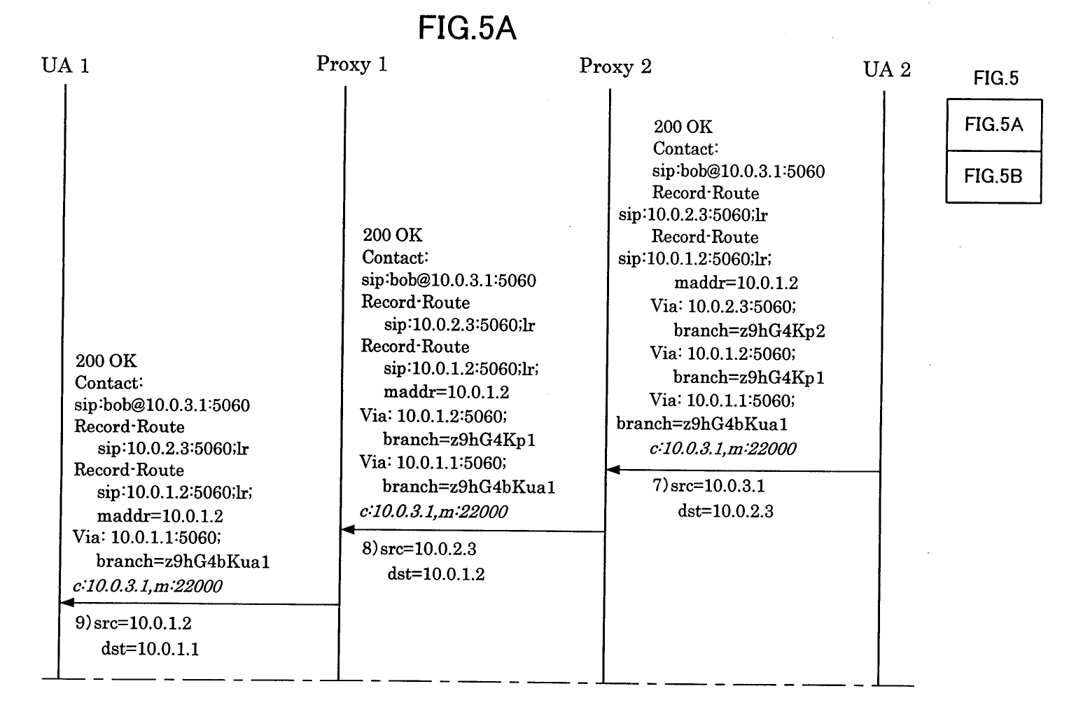

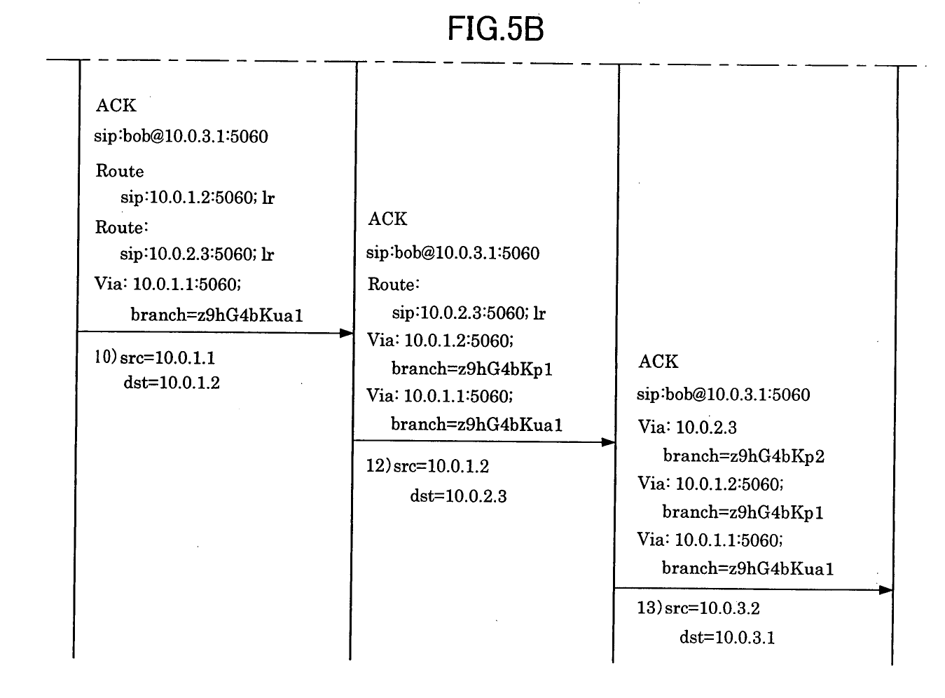

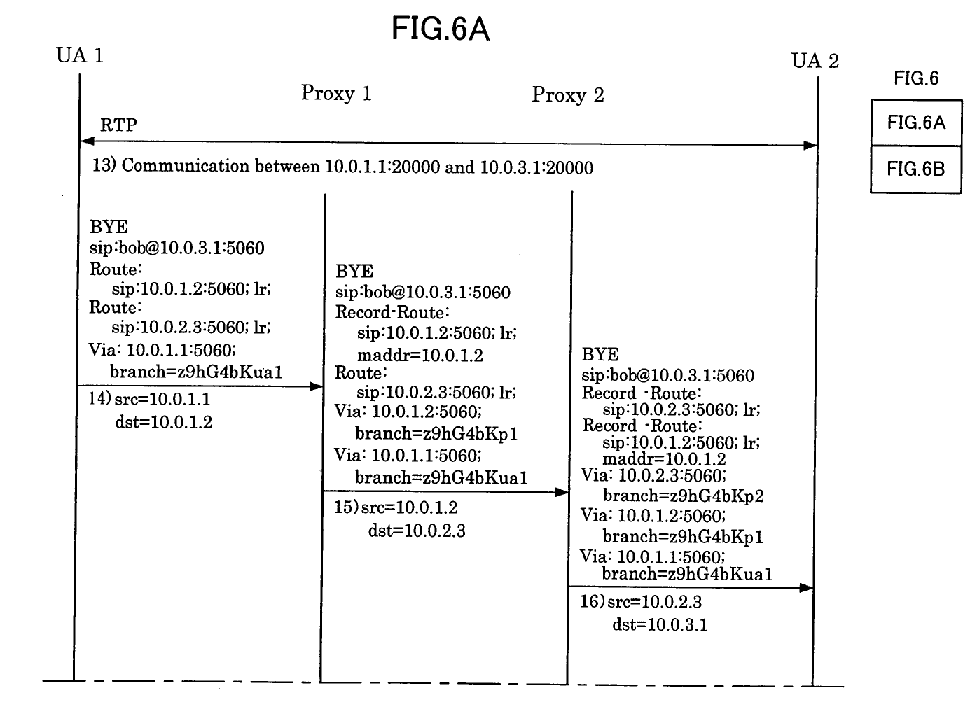

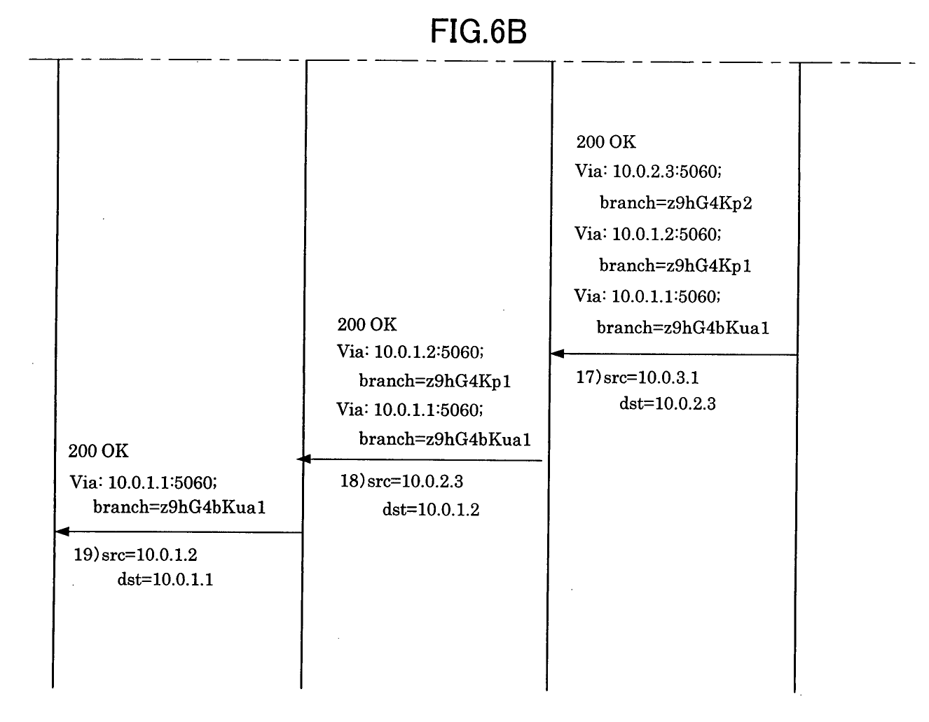

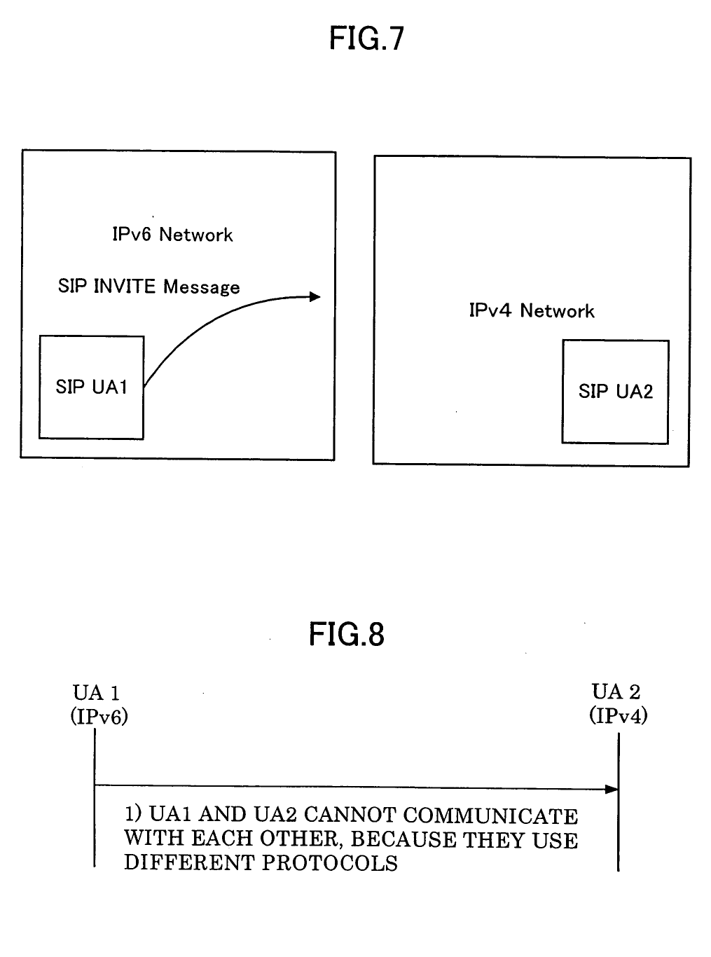

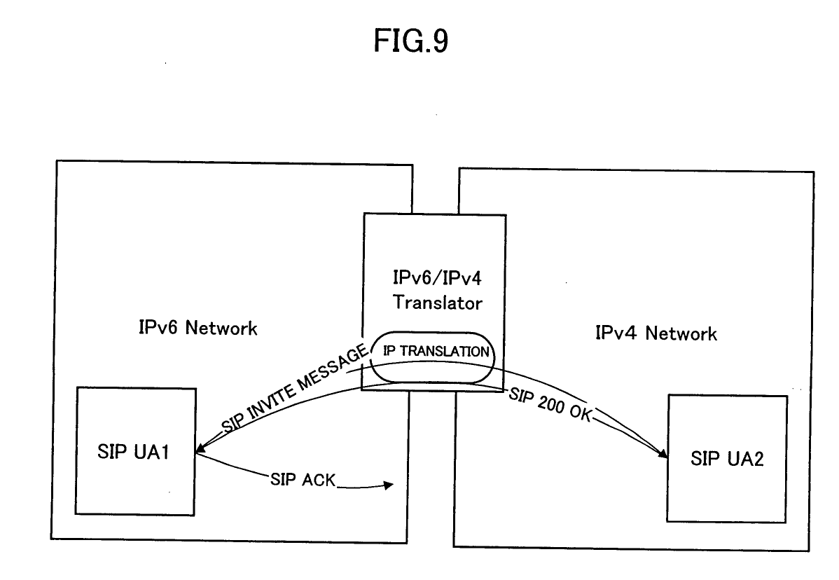

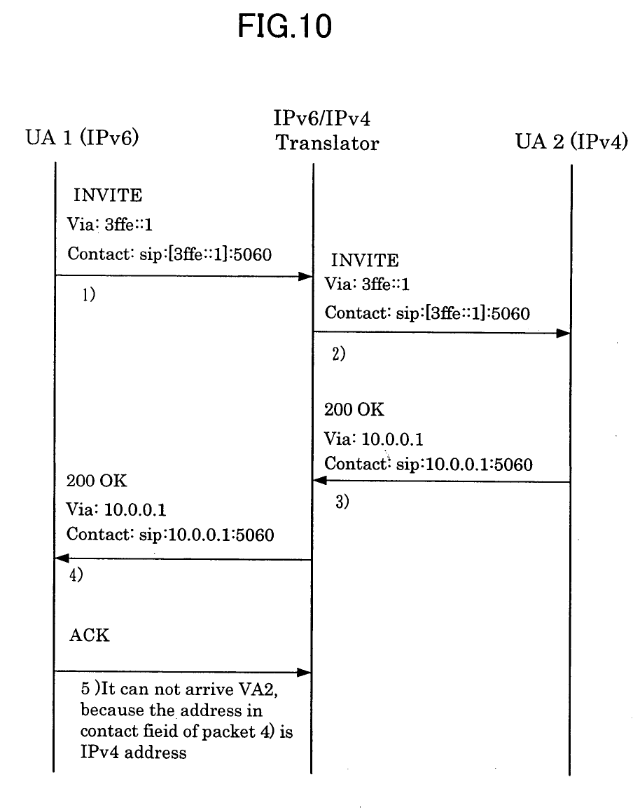

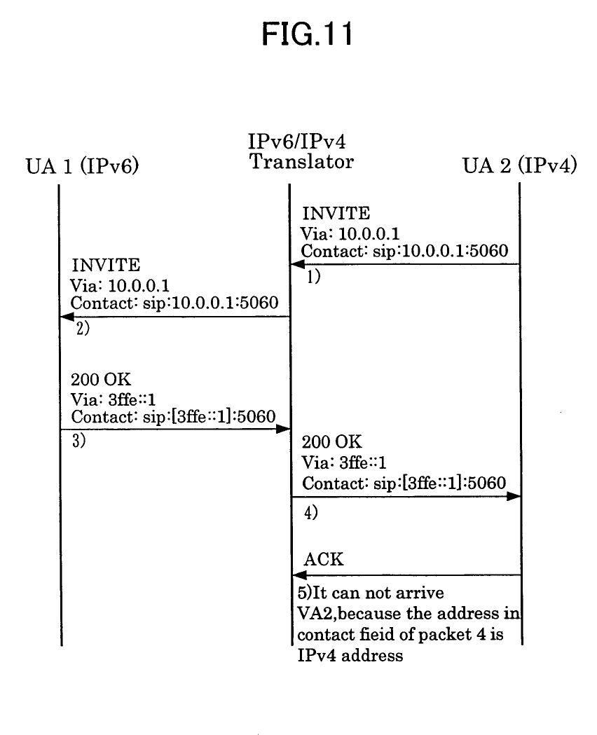

### DESCRIPTION OF THE PREFERRED EMBODIMENTS

The present invention is explained in further detail referring to the drawings.

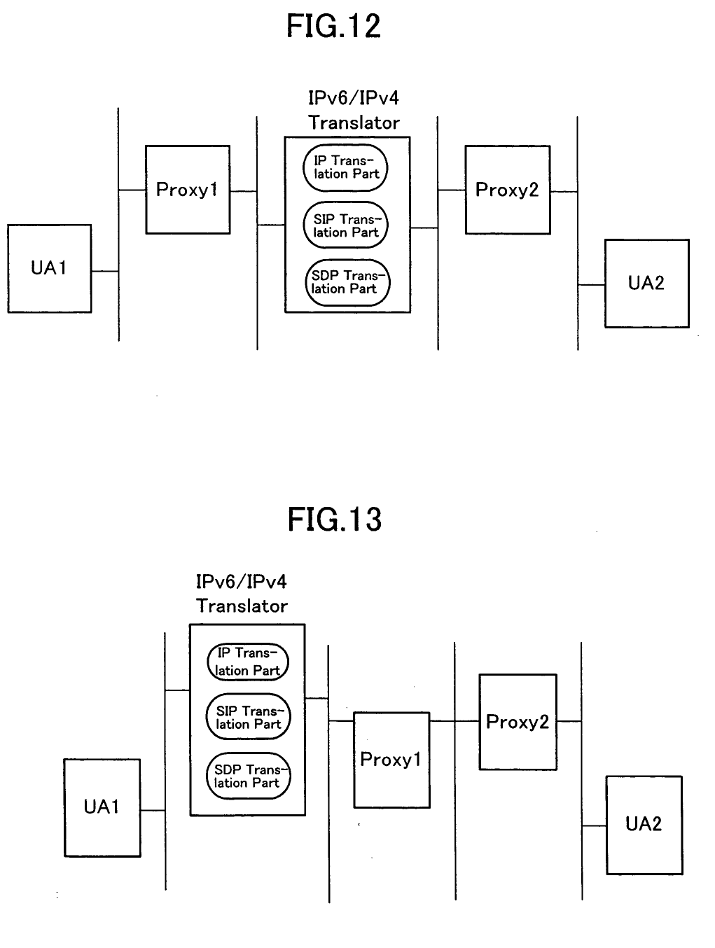

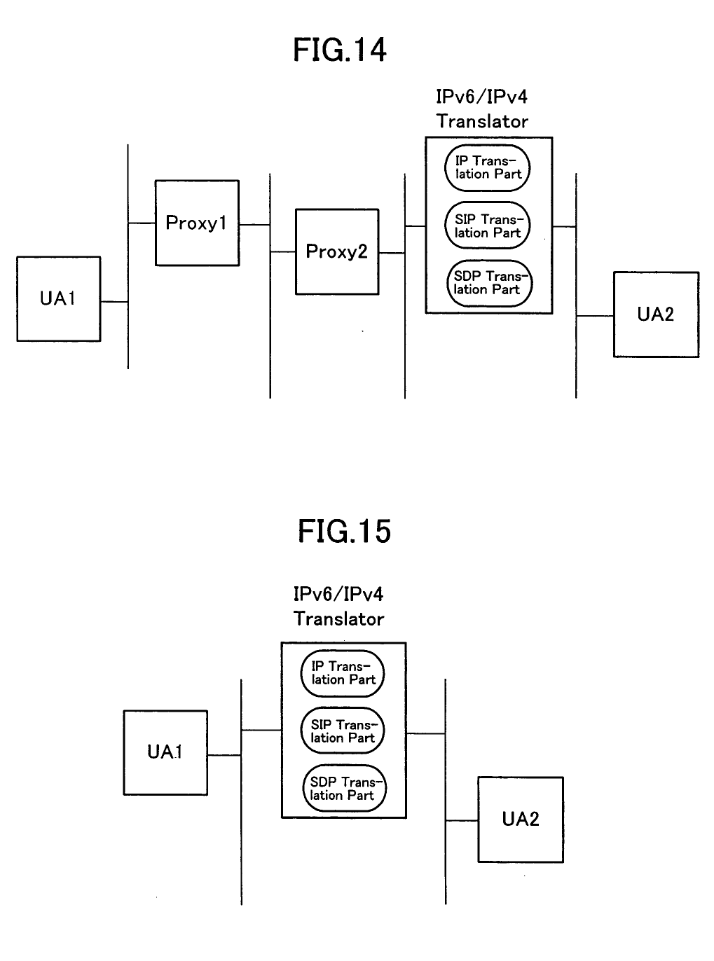

FIG. 12 is a configuration diagram wherein an IPv6/IPv4 translator is connected between SIP Proxy (Proxy1) and SIP Proxy (Proxy2). FIG. 13 is a configuration diagram wherein an IPv6/IPv4 translator is connected between UA1 and SIP Proxy (Proxy1), FIG. 14 is a configuration diagram wherein an IPv6/IPv4 translator is connected between SIP Proxy (Proxy2) and UA2, and FIG. 15 is a configuration diagram wherein SIP Proxy is not used. Here, FIG. 12 is the most fundamental configuration and includes the variations shown in FIG. 13 and FIG. 14.

The IPv6/IPv4 translator for use in FIG. 12 to 15 is provided with an IP translation part for address translations between IPv6 and IPv4, an SIP translation part for translating addresses described in SIP messages into IPv6 addresses or IPv4 addresses, an SDP translation part for translating addresses described in SDP messages into IPv6 addresses or IPv4 addresses, and so on. Note that the SDP translation part may not be provided in some applications.

Moreover, for realizing SIP communication by means of an IPv6/IPv4 translator between a terminal UA1 connected to an IPv6 network and a terminal UA2 connected to an IPv4 network, SIP Proxy may be used as illustrated in FIG. 12 or SIP Proxy may not be used as illustrated in FIG. 15. Furthermore, Record-Route may or may not be used in the configuration of FIG. 12

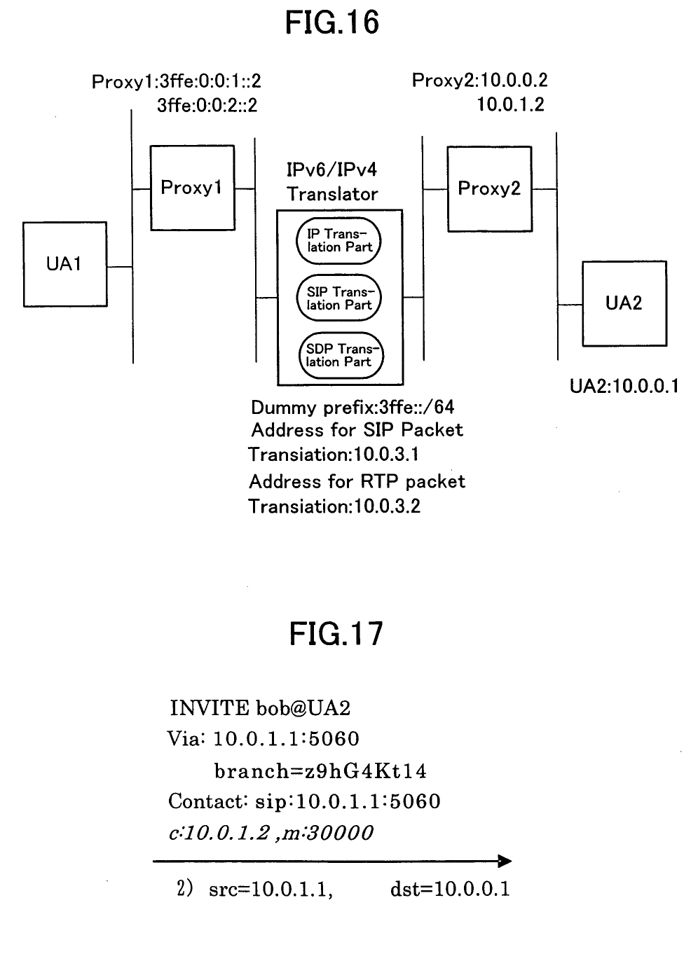

Referring now to FIG. 16 wherein addresses are provided to elements of FIG. 12 which is the most fundamental configuration, UA1 and UA2 communicate with each other via an IPv6/IPv4 translator. In order to map IPv4 addresses to IPv6 addresses, a unique IPv6 prefix is preset to the IPv6/IPv4 translator. This prefix is called “a dummy prefix.” In addition, necessary settings are provided in advance to UA1, UA2, SIP Proxy1 and SIP Proxy2 so that the IPv6/IPv4 translator can be used. Addresses of terminals in FIG. 16 are as follows:
UA1 (IPv6): 3ffe:0:0:1::1
UA2 (IPv4): 10.0.0.1
UA2's IPv6 address with a dummy prefix: 3ffe:ffff::10.0.0.1
Dummy prefix: 3ffe:ffff::/64
Proxy1 (IPv6): 3ffe:0:0:1::2/3ffe:0:0:2::2
Proxy2 (IPv4): 10.0.0.2/10.0.1.2
IPv4 address for SIP packet translation: 10.0.3.1
IPv4 address for RTP packet translation: 10.0.3.2

FIG. 17 shows an SIP message which UA1 and UA2 use for communication. In FIG. 17, the SIP message represents the necessary elements only. The italicized element represents an SDP message. The highlighted characters mean that translation was performed by an IPv6/IPv4 translator. “src” and “dst” that follow a number represent the source address and the destination address of the relevant packet.

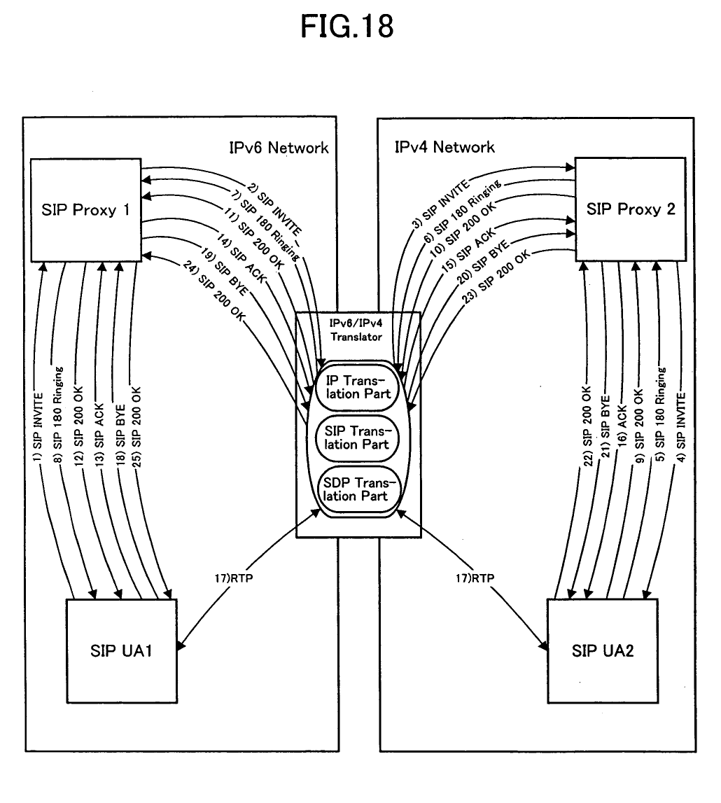

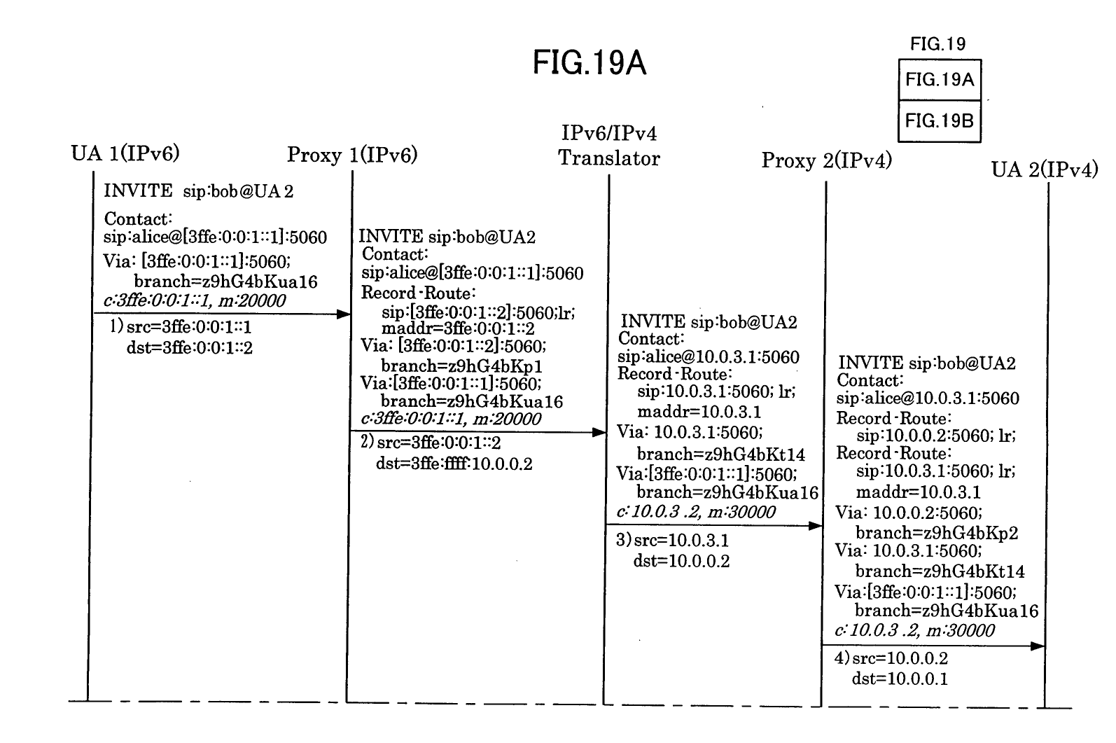

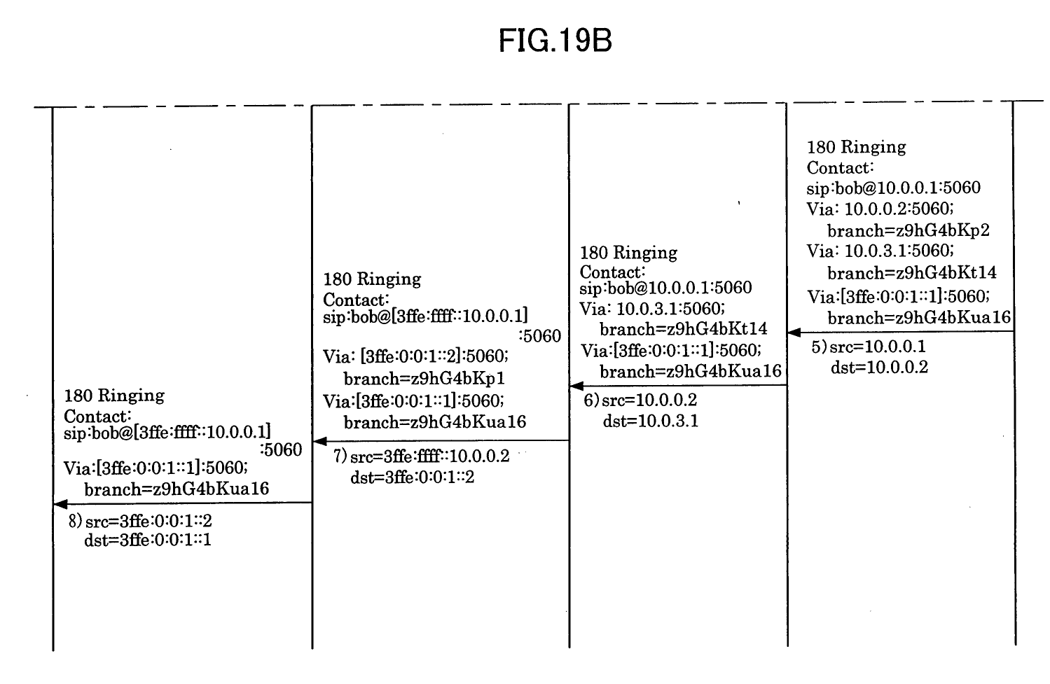

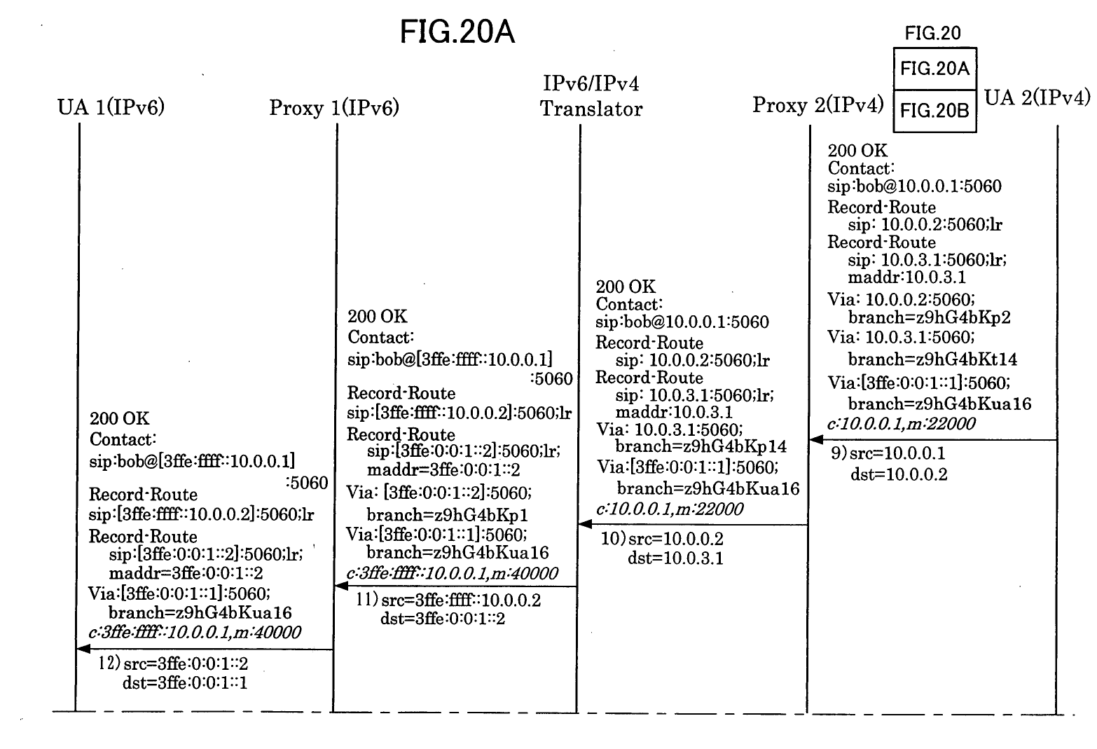

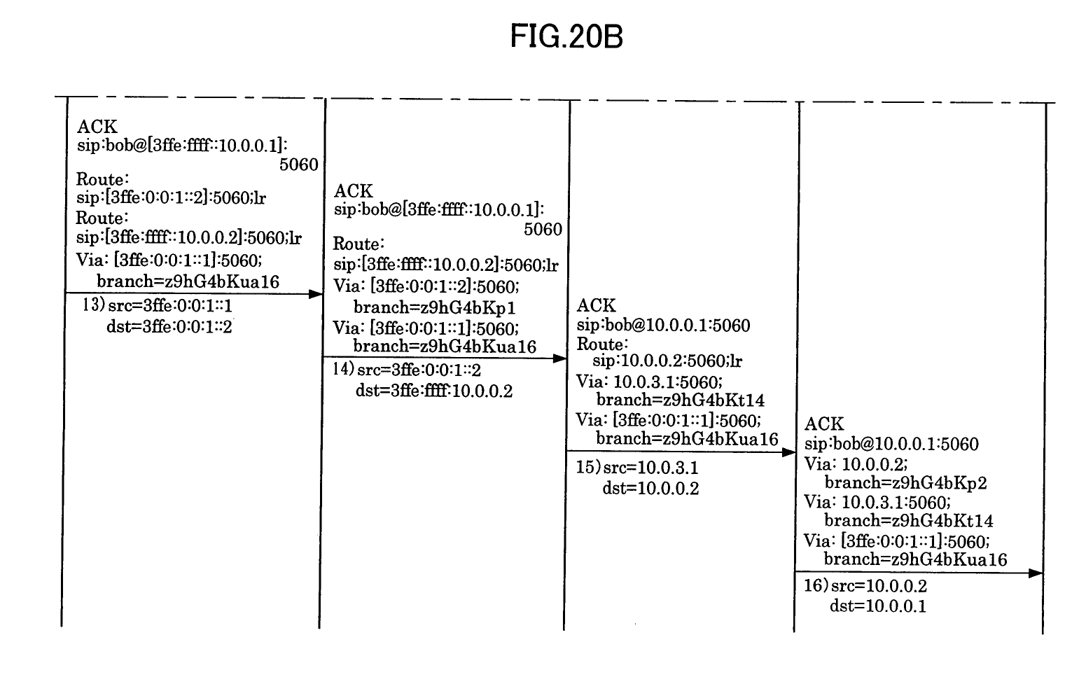

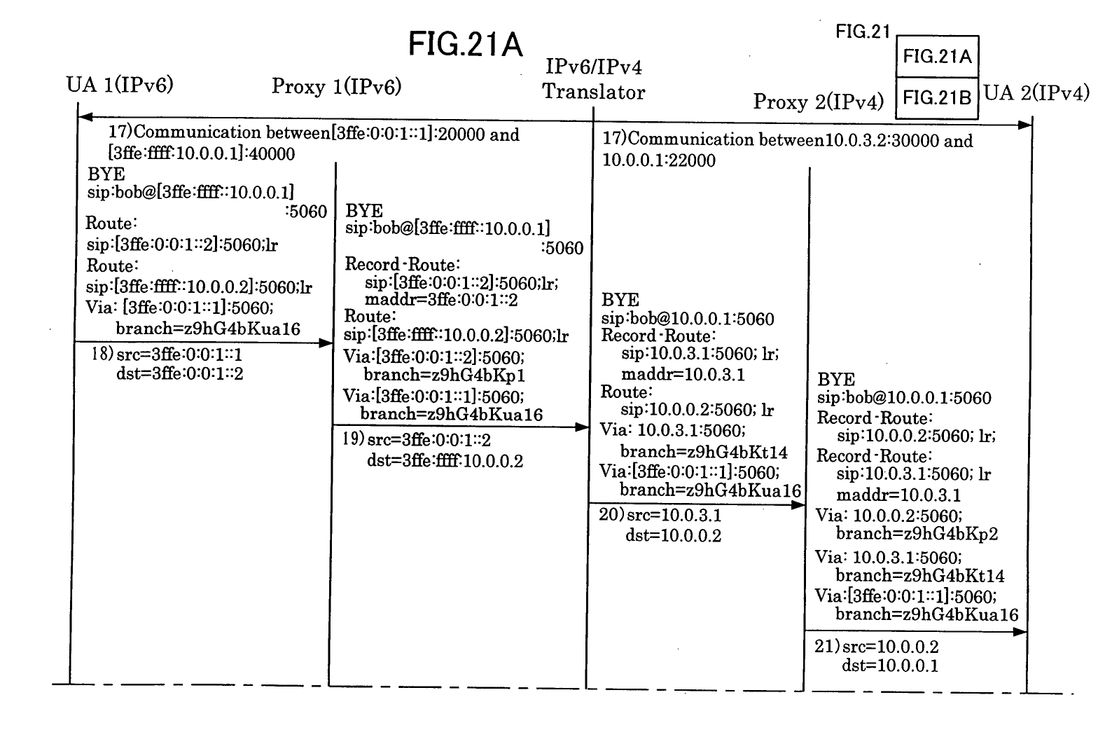

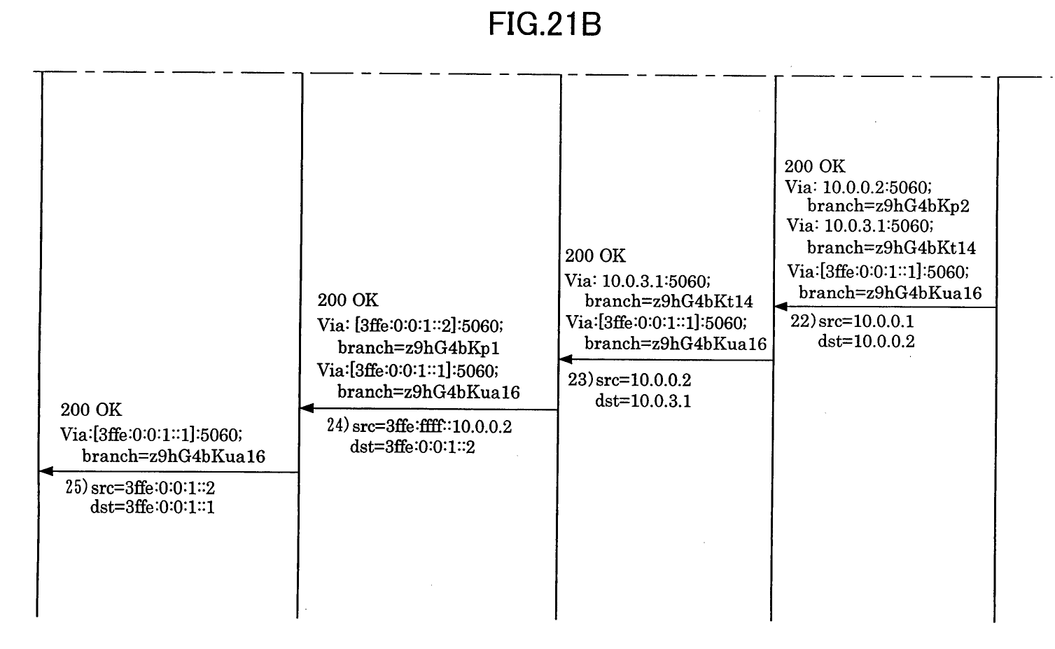

FIG. 18 is a conceptual example diagram of communication from a terminal UA1 “alice” to a terminal UA2 “bob”. FIG. 19 to 21 are operational diagrams of FIG. 18.
1) UA1 sends an INVITE message to UA2. The destination address of this packet is the IPv6 address of SIP Proxy1.
2) SIP Proxy1 which received packet 1) adds its own address to a Via field and a Record-Route field, and forwards the packet to SIP Proxy2. The destination address of this packet is the IPv6 address generated from the IPv4 address of SIP Proxy2 and a dummy prefix.
3) The packet which has a dummy prefix for destination is delivered to the IPv6/IPv4 translator. The IPv6/IPv4 translator translates the packet from IPv6 to IPv4. At the same time, the IPv6/IPv4 translator translates addresses of a first Via field of the INVITE message, a Record-Route field, and a Contact field into an address for SIP translation (which is 10.0.3.1 here) which has been set to the IPv6/IPv4 translator itself. Moreover, the IPv6/IPv4 translator reconfigures the branch of the Via field and, if “maddr” exists in the Record-Route field, performs the translation into an address for SIP translation (which is 10.0.3.1 here). Furthermore, in order to translate media data (in the case of VoIP, voice data), the IPv6/IPv4 translator translates the Connection Information field (c) and the Media Description, name and address field (m) of an SDP message into an address (which is 10.0.3.2 here), which has been set for RTP translation in the IPv6/IPv4 translator, and an arbitrary port (which is port 30000 here).
4) Proxy2 which received packet 3) adds its own address to the Via field and the Record-Route field, and forwards the packet to UA2.
5) After receiving packet 4), UA2 sends a 180 Ringing message. The destination address of this packet is the IPv4 address of SIP Proxy2.
6) After receiving packet 5), SIP Proxy2 deletes the Via field that SIP Proxy2 itself added, and forwards the packet to SIP Proxy1. The destination address of this packet is the address for SIP translation (10.0.3.1) which has been set to the IPv6/IPv4 translator itself.
7) The packet which has an address for SIP translation for destination is delivered to the IPv6/IPv4 translator. The IPv6/IPv4 translator translates the packet from IPv4 to IPv6. At the same time, the IPv6/IPv4 translator changes an address of the Contact field to an IPv6 address which is generated from a dummy prefix and an address of UA2. The IPv6/IPv4 translator restores the Via field of packet 6) consistent with the branch of the Via field, which was included when the IPv6/IPv4 translator translated packet 2) into packet 3).
8) After receiving packet 7), SIP Proxy1 deletes the Via field that SIP Proxy1 itself added, and forwards the packet to UA1.
9) When communication has become enabled in UA2 (in the case of a telephone, when its receiver is picked up), an 200 OK message is sent to UA1. The destination address of this packet is the IPv4 address of SIP Proxy2.
10) SIP Proxy2 deletes the Via field, which SIP Proxy2 itself added, from packet 9), and forwards the packet to SIP Proxy1. The destination address of this packet is the address for SIP translation (10.0.3.1) which has been set to the IPv6/IPv4 translator itself.
11) The packet which has an address for SIP translation for destination is delivered to the IPv6/IPv4 translator. The IPv6/IPv4 translator translates the packet from IPv4 to IPv6. At the same time, the IPv6/IPv4 translator changes an address of the Contact field into an IPv6 address, which is generated from a dummy prefix and an address of UA2. The IPv6/IPv4 translator restores the Via field of packet 10) consistent with the branch of the Via field, which was included when the IPv6/IPv4 translator translated packet 2) into packet 3). Moreover, in order to translate media data (in the case of VoIP, voice data), the IPv6/IPv4 translator changes the Connection Information field (c) of the SDP message into an IPv6 address, which is generated from a dummy prefix and an IPv4 address, and translates the Media Description, name and address field (m) into an arbitrary port (which is port 40000 here).
12) SIP Proxy1 deletes the VIA field that SIP Proxy1 itself added, and forwards the message to UA1.
13) UA1 sends an ACK message to UA2. The Request-URI of this message is determined on the basis of the Contact field of packet 12). Moreover, the destination address of this packet is the IPv6 address of SIP Proxy1.
14) SIP Proxy1 deletes its own Route field from packet 13), adds its address to the Via field, and forwards the packet to SIP Proxy2. The destination address of this packet is the IPv6 address, which is generated from an IPv4 address of SIP Proxy2 and a dummy prefix.
15) The packet which has a dummy prefix for destination is delivered to the IPv6/IPv4 translator. The IPv6/IPv4 translator translates the packet from IPv6 to IPv4. At the same time, the IPv6/IPv4 translator changes the addresses of a first Via field and a first Record-Route field of the ACK message into an address for SIP translation (which is 10.0.3.1 here), which has been set to the IPv6/IPv4 translator itself, and reconfigures the branch of the Via field. The Route field is translated on the basis of the Record-Route field which the IPv6/IPv4 translator translated from packet 10) into packet 11) before.
16) SIP Proxy2 deletes its own Route field from packet 15), adds its address to the Via field, and forwards the packet to UA2.
17) RTP communication starts between UA1 and UA2 via the IPv6/IPv4 translator. Information such as respective destinations, ports, and so on is then determined on the basis of the Connection Information field (c) and the Media Description, name and address field (m) of the messages which were exchanged in steps 1) to 4) and 9) to 12).
18) UA1 sends a BYE message to SIP Proxy1. The Request-URI of this message is determined on the basis of the Contact field of packet 12).
19) SIP Proxy1 deletes its own Route field, adds its address to the Via field and the Record-Route field, and forwards the packet to SIP Proxy2. The destination address of this packet is the IPv6 address which is generated from a dummy prefix and an IPv4 address of SIP Proxy2.
20) The packet which has a dummy prefix for destination is delivered to the IPv6/IPv4 translator. The IPv6/IPv4 translator translates the packet from IPv6 into IPv4. At the same time, the IPv6/IPv4 translator changes addresses of a first Via field and a first Record-Route field into an address for SIP translation (which is 10.0.3.1 here) which has been set to the IPv6/IPv4 translator itself, reconfigures the branch of the Via field, and, if “maddr” exists in the Record-Route field, performs the translation into an address (10.0.3.1) for SIP translation. The IPv6/IPv4 translator restores the Route field and the Request-URI to their original states before translation on the basis of the Record-Route field and the Contact field when the IPv6/IPv4 translator translated from packet 10) into packet 11) before.
21) SIP Proxy2 deletes its own Route field from packet 20), adds its address to the Via field, and forwards the packet to UA2.
22) UA2 sends a “200 OK” message.
23) SIP Proxy2 deletes its own Via field from packet 22) and forwards the packet to SIP Proxy1. The destination address of this packet is the address (10.0.3.1) for SIP translation, which has been set to the IPv6/IPv4 translator itself.
24) The packet which has an address for SIP translation for destination is delivered to the IPv6/IPv4 translator. The IPv6/IPv4 translator translates the packet from IPv4 to IPv6. At the same time, the IPv6/IPv4 translator restores the Via field of packet 23) consistent with the branch of the Via field, which was included when the IPv6/IPv4 translator translated packet 19) into packet 20).
25) SIP Proxy1 deletes its own Via field from packet 24) and forwards the packet to UA1.

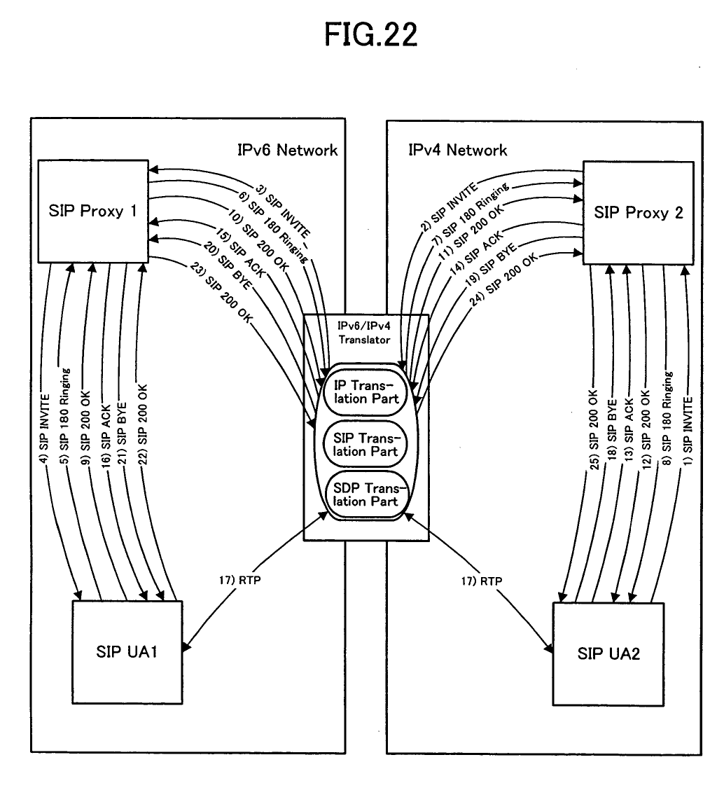

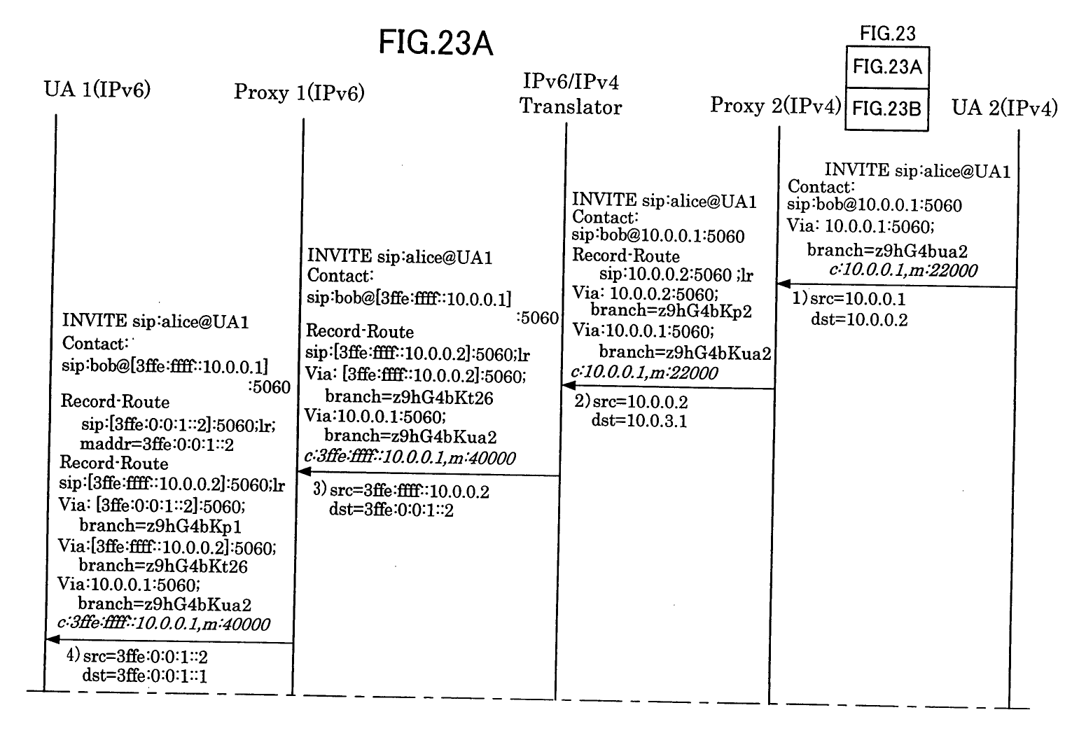

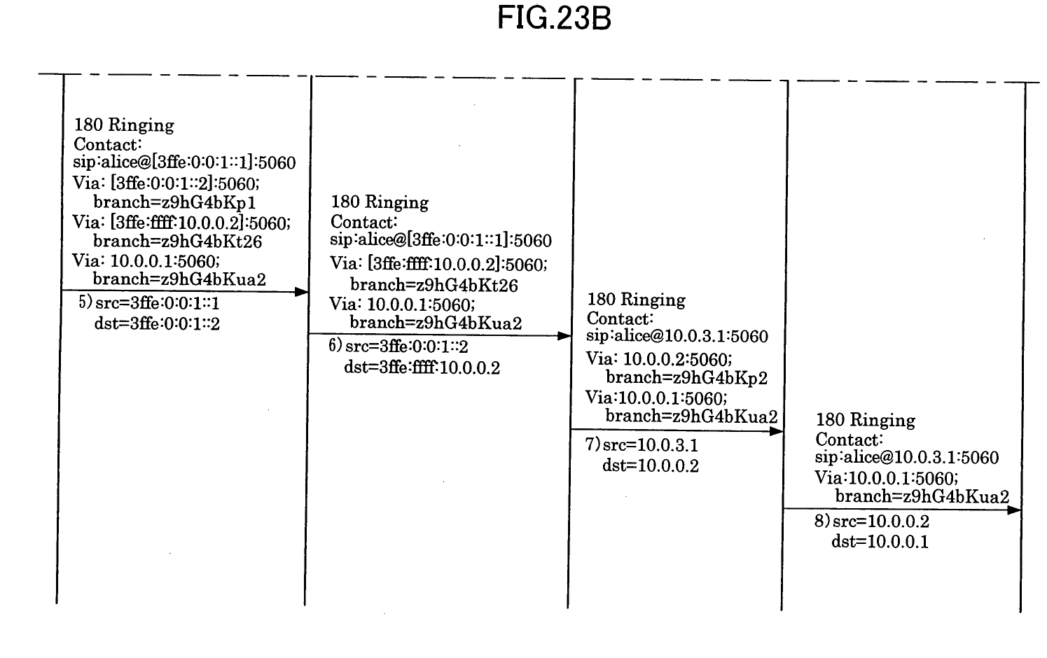

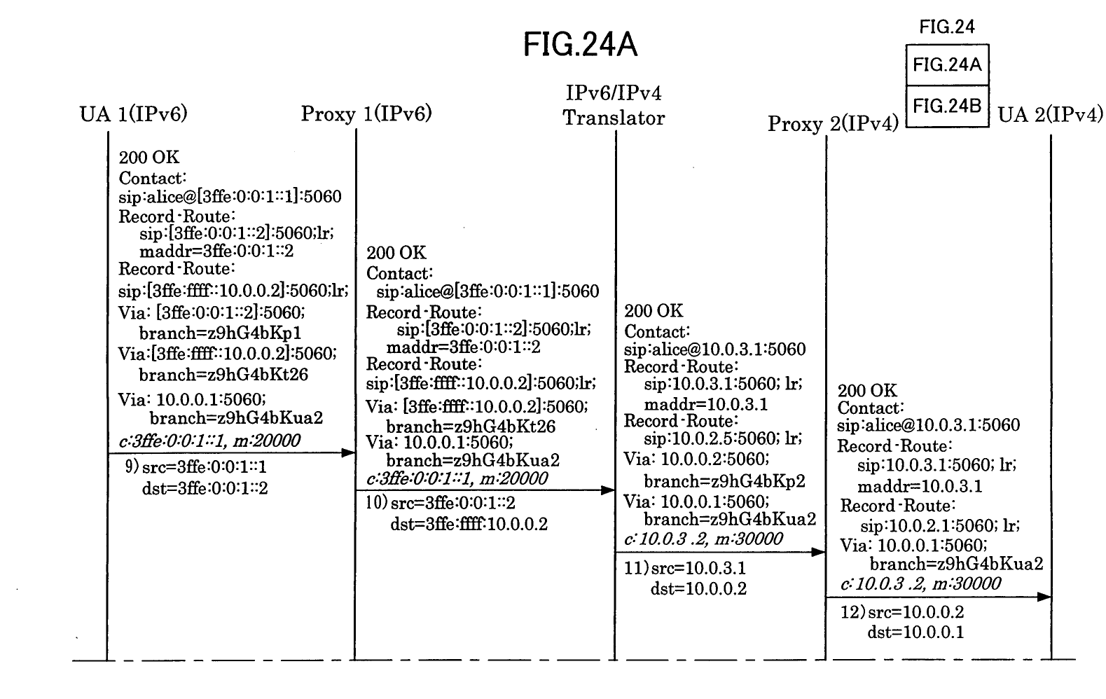

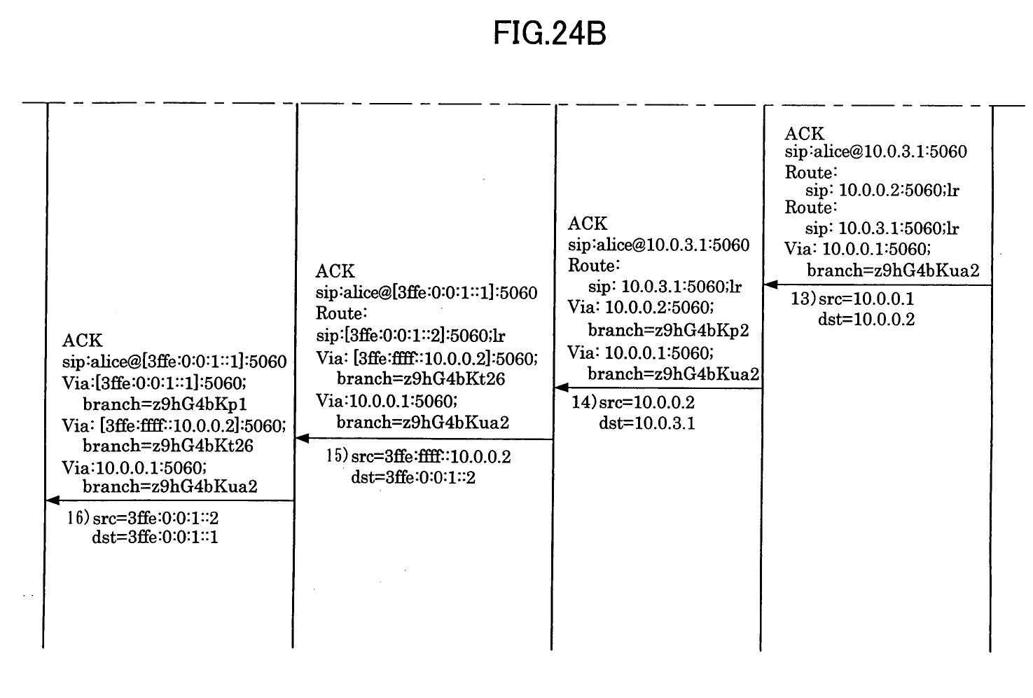

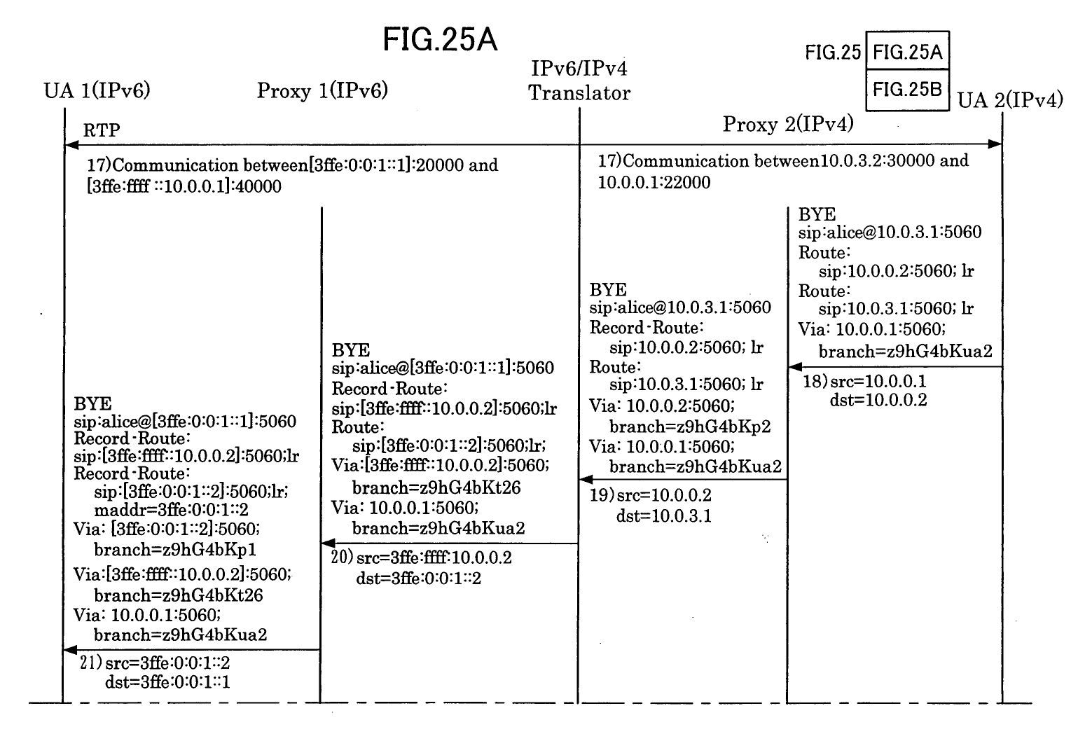

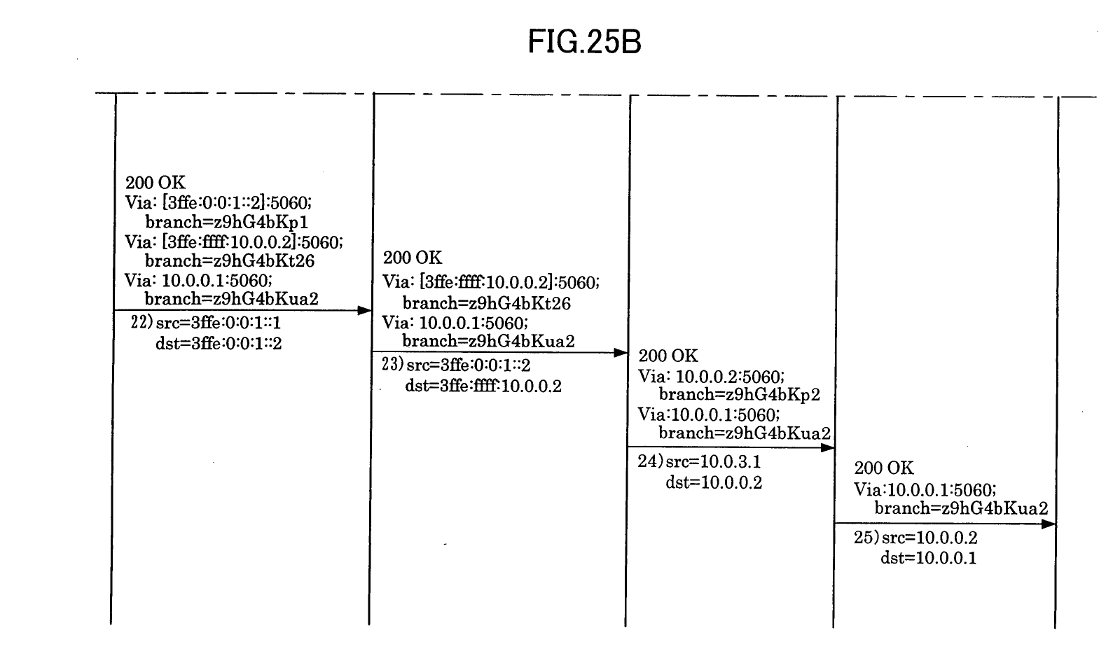

FIG. 22 is a conceptual example diagram of communication from a terminal UA2 “bob” to a terminal UA1 “alice”. FIG. 23 to 25 are operational diagrams of FIG. 22.
1) UA2 sends an INVITE message to UA1. The destination address of this packet is the IPv4 address of SIP Proxy2.
2) SIP Proxy2 which received packet 1) adds the address of SIP Proxy1 itself to the Via field and the Record-Route field, and forwards the packet to SIP Proxy1. The destination address of this packet is an address for SIP translation (which is 10.0.3.1 here), which has been set to the IPv6/IPv4 translator itself.
3) The packet which has an address for SIP translation for destination is delivered to the IPv6/IPv4 translator. The IPv6/IPv4 translator translates the packet from IPv4 to IPv6. At the same time, the IPv6/IPv4 translator translates addresses of a first Via field,a Record-Route field, and a Contact field of the INVITE message into an IPv6 address which is generated from a dummy prefix and a described IPv4 address. Moreover, the IPv6/IPv4 reconfigures the branch of the Via field and, if “maddr” exists in the Record-Route field, performs the translation into an IPv6 address which is generated from a dummy prefix and an IPv4 address. Furthermore, in order to translate media data (in the case of VoIP, voice data), the IPv6/IPv4 translator translates the Connection Information field (c) and the Media Description, name and address field (m) of an SDP message into an IPv6 address, which is generated from a dummy prefix and an IPv4 address, and an arbitrary port (which is port 40000 here).
4) SIP Proxy1 which received packet 3) adds its own address to the Via field and the Record-Route field, and forwards the packet to UA1.
5) After receiving packet 4), UA1 sends a 180 Ringing message. The destination address of this packet is the IPv6 address of SIP Proxy1.
6) SIP Proxy1 deletes the Via field that SIP Proxy1 itself added after receiving packet 5), and forwards the packet to SIP Proxy2. The destination address of this packet is an IPv6 address which is generated from an IPv4 address of SIP Proxy2 and a dummy prefix.
7) The packet which has a dummy prefix for destination is delivered to the IPv6/IPv4 translator. The IPv6/IPv4 translator translates the packet from IPv6 to IPv4. At the same time, the IPv6/IPv4 translator translates an address of the Contact field to an address (10.0.3.1) for SIP translation which has been set to the IPv6/IPv4 itself. The IPv6/IPv4 translator restores the Via field of packet 6) consistent with the branch of the Via field, which was included when the IPv6/IPv4 translator translated packet 2) into packet 3).
8) SIP Proxy2 which received packet 7) deletes the Via field that SIP Proxy2 itself added, and forwards the packet to UA2.
9) When communication has become enabled in UA1 (in the case of a telephone, when its receiver is picked up), a 180 OK message is sent to UA2. The destination address of this packet is an IPv6 address of SIP Proxy1.
10) SIP Proxy1 deletes the Via field, which SIP Proxy1 itself added, from packet 9), and forwards the packet to SIP Proxy2. The destination address of this packet is an IPv6 address which is generated from an IPv4 address of SIP Proxy2 and a dummy prefix.
11) The packet which has a dummy prefix for destination is delivered to the IPv6/IPv4 translator. The IPv6/IPv4 translator translates the packet from IPv6 to IPv4. At the same time, the IPv6/IPv4 translator translates an address of the Contact field into an address for SIP translation (10.0.3.1) which has been set to the IPv6/IPv4 translator. Moreover, the IPv6/IPv4 translator restores the Via field of packet 10) consistent with the branch of the Via field, which was included when the IPv6/IPv4 translator translated packet 2) into packet 3). Furthermore, in order to translate media data (in the case of VoIP, voice data), the IPv6/IPv4 translator translates the Connection Information field (c) of an SDP message into an address for RTP translation (which is 10.0.3.2 here), which has been set to the IPv6/IPv4 translator itself, and an arbitrary port (which is port 30000 here).
12) SIP Proxy2 deletes the Via field that SIP Proxy2 itself added, and forwards the message to UA2.
13) UA2 sends an ACK message to UA1. The Request-URI of this message is determined on the basis of the Contact field of packet 12). Moreover, the destination address of this packet is the IPv4 address of SIP Proxy2.
14) SIP Proxy2 deletes its own Route field from packet 13), adds its address to the Via field, and forwards the packet to SIP Proxy1. The destination address of this packet is an address for SIP translation (which is 10.0.3.1 here), which has been set to the IPv6/IPv4 translator itself.
15) The packet which has an address for SIP translation for destination is delivered to the IPv6/IPv4 translator. The IPv6/IPv4 translator translates the packet from IPv4 to IPv6. At the same time, the IPv6/IPv4 translator translates the address of a first Via field of the ACK message into an IPv6 address which is generated from a dummy prefix and an IPv4 address, and reconfigures the branch of the Via field. The Route field is translated on the basis of Record-Routed which the IPv6/IPv4 translator translated from packet 10) into packet 11) before.
16) SIP Proxy1 deletes its own Route field from packet 15), adds its address to the Via field, and forwards the packet to UA1.
17) RTP communication starts between UA1 and UA2 via the IPv6/IPv4 translator. Information such as respective destinations, ports, and so on is then determined on the basis of the Connection Information field (c) and the Media Description, name and address field (m) of the messages which were exchanged in steps 1) to 4) and 9) to 12).
18) UA2 sends a BYE message to UA1. The Request-URI of this message is determined on the basis of the Contact field of packet 12). Moreover, the destination address of this packet is an IPv4 address of SIP Proxy2.
19) SIP Proxy2 deletes its own Route field, adds its own address to the Via field and the Record-Route field, and forwards the packet to SIP Proxy1. The destination address of this packet is an address for SIP translation (which is 10.0.3.1 here), which has been set to the IPv6/IPv4 translator.
20) The packet which has an address for SIP translation for destination is delivered to the IPv6/IPv4 translator. The IPv6/IPv4 translator translates the packet from IPv4 into IPv6. At the same time, the IPv6/IPv4 translator translates addresses of a first Via field and a first Record-Route field into an IPv6 address which is generated from a dummy prefix and an IPv4 address, reconfigures the branch of the Via field, and, if “maddr” exists in the Record-Route field, performs the translation into an IPv6 address which is generated from a dummy prefix and an IPv4 address. The Route field and the Request-URI are translated on the basis of the Record-Route field and the Contact field when the IPv6/IPv4 translator translated from packet 10) into packet 11).
21) SIP Proxy1 deletes its own Route field from packet 20), adds its address to the Via field, and forwards the packet to UA1.
22) UA1 sends a “200 OK” message.
23) SIP Proxy1 deletes its own Via field from packet 22) and forwards the packet to SIP Proxy2. The address of this packet is an IPv6 address which is generated from an IPv4 address and a dummy prefix.
24) The packet which has a dummy prefix for destination is delivered to the IPv6/IPv4 translator. The IPv6/IPv4 translator translates the packet from IPv6 to IPv4. At the same time, the IPv6/IPv4 translator restores the Via field of packet 23) consistent with the branch of the Via field, which was included when the IPv6/IPv4 translator translated packet 19) into packet 20).
25) SIP Proxy2 deletes its own Via field from packet 24) and forwards the packet to UA2.

In these configurations, the IPv6/IPv4 translator also translates an SIP message when translating a packet from IPv6 to IPv4 or from IPv4 to IPv6, so that communication not only from SIP UA supporting only IPv6 to SIP UA supporting only IPv4, but also from SIP UA supporting only IPv4 to SIP UA supporting only IPv6 will become possible.

Moreover, the IPv6/IPv4 translator also translates SDP messages when translating packets from IPv6 to IPv4 or from IPv4 to IPv6, so that it will be possible to perform RTP communication for establishing sessions in accordance with SIP from IPv6 to IPv4 or, conversely, from IPv4 to IPv6.

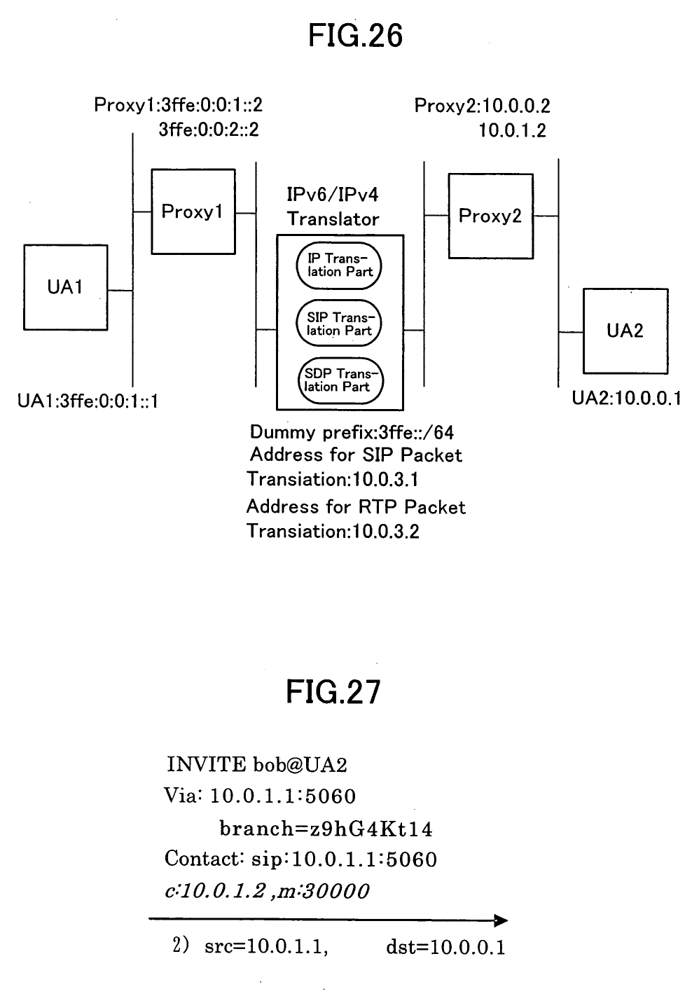

FIG. 26 illustrates that addresses are provided to elements of FIG. 12 for communications with an IPv6/IPv4 translator connected between SIP Proxy (Proxy1) and SIP Proxy (Proxy2) but without using Record-Route. In FIG. 26, a unique IPv6 prefix called “dummy prefix” is preset to the IPv6/IPv4 translator for mapping IPv4 addresses to IPv6 addresses. In addition, UA1, UA2, SIP Proxy1, and SIP Proxy2 are preset so that they can use the IPv6/IPv4 translator. Addresses of terminals in FIG. 26 are as follows:
UA1 (IPv6): 3ffe:0:0:1::1
UA2 (IPv4): 10.0.0.1
IPv6 address of UA2 with a dummy prefix: 3ffe:ffff::10.0.0.1
Dummy prefix: 3ffe:ffff::/64
Proxy1 (IPv6): 3ffe:0:0:1::2/3ffe:0:0:2::2
Proxy2 (IPv4): 10.0.0.2/10.0.1.2
IPv4 address for SIP packet translation: 10.0.3.1
IPv4 address for RTP packet translation: 10.0.3.2

FIG. 27 shows an SIP message that UA1 and UA2 use for communication. In FIG. 27, the SIP message represents necessary elements only. The italicized element shows an SDP message. The highlighted characters mean that they were translated by an IPv6/IPv4 translator. “src” and dst” that follow a number represent the source address and destination address of the relevant packet.

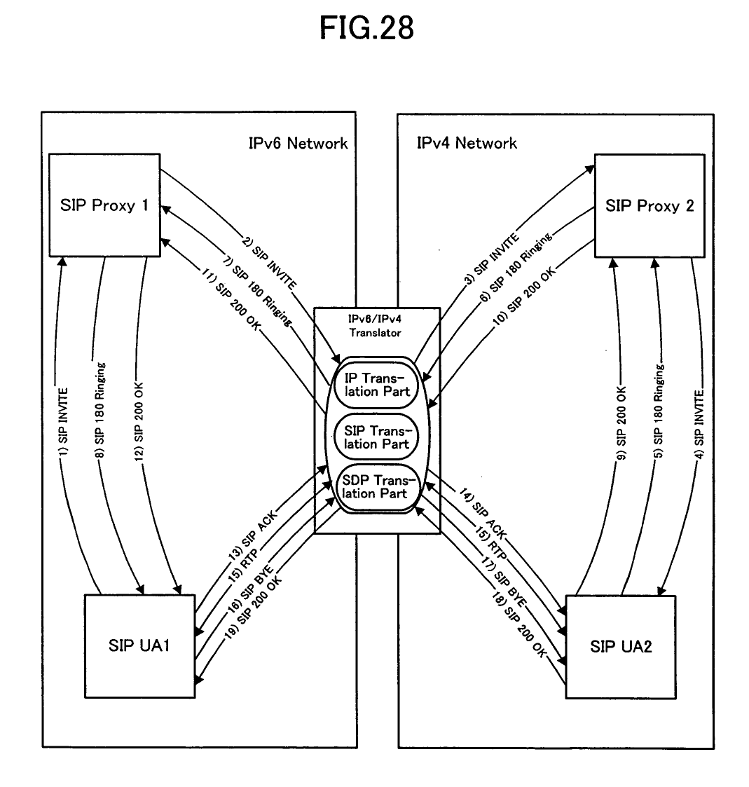

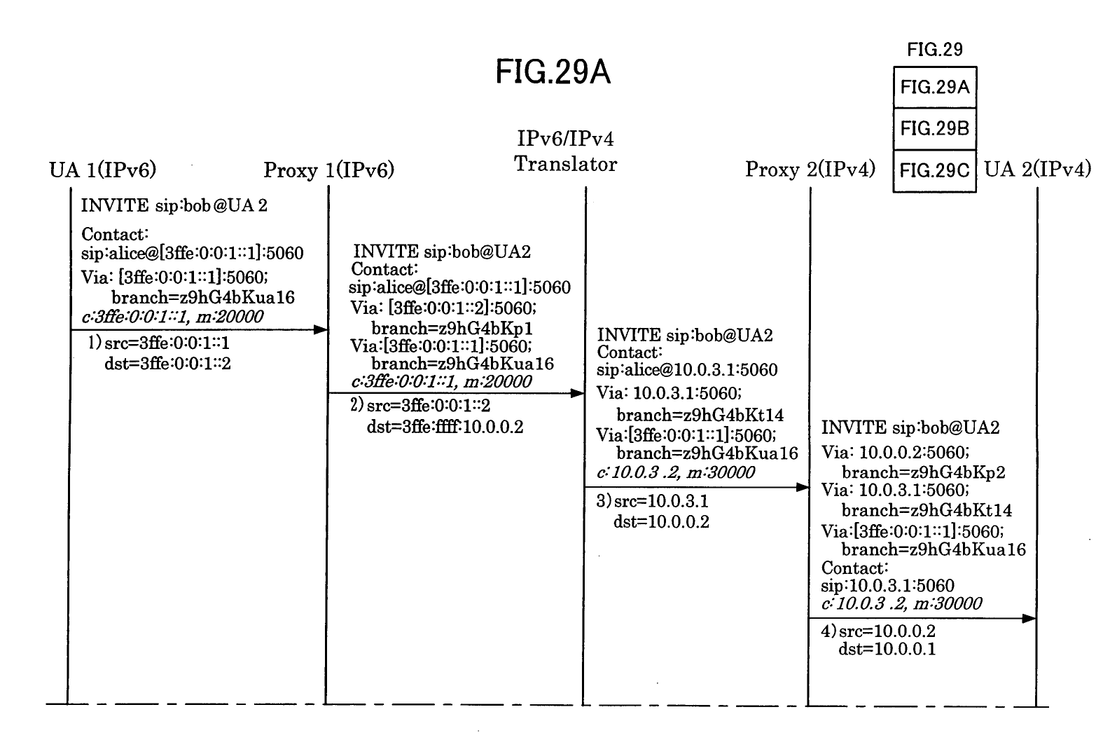

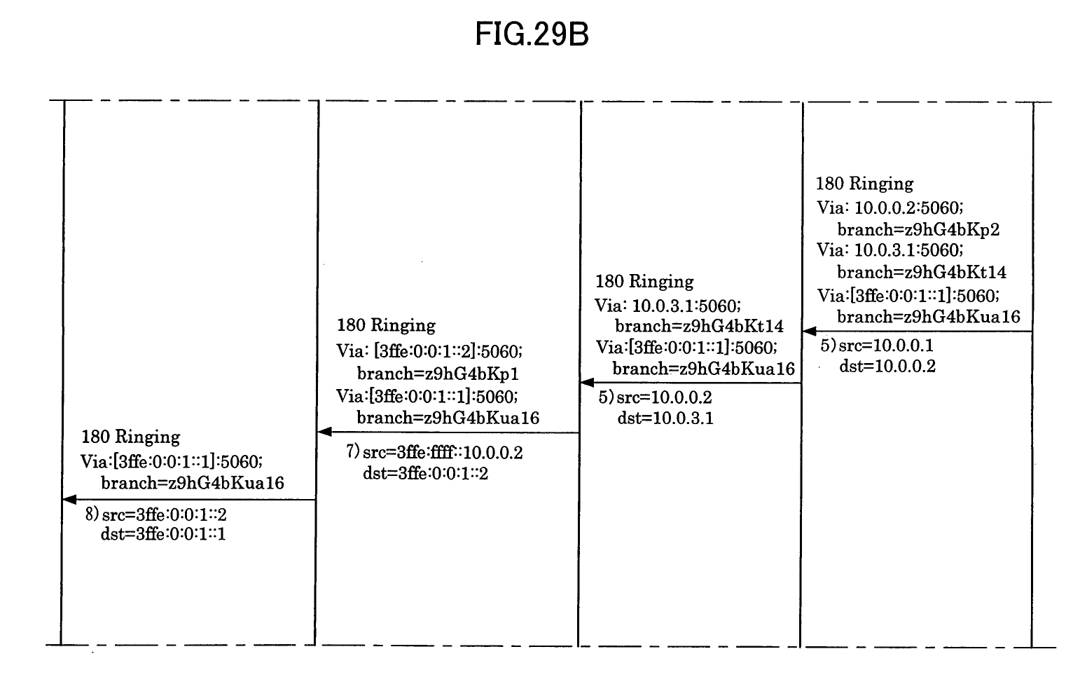

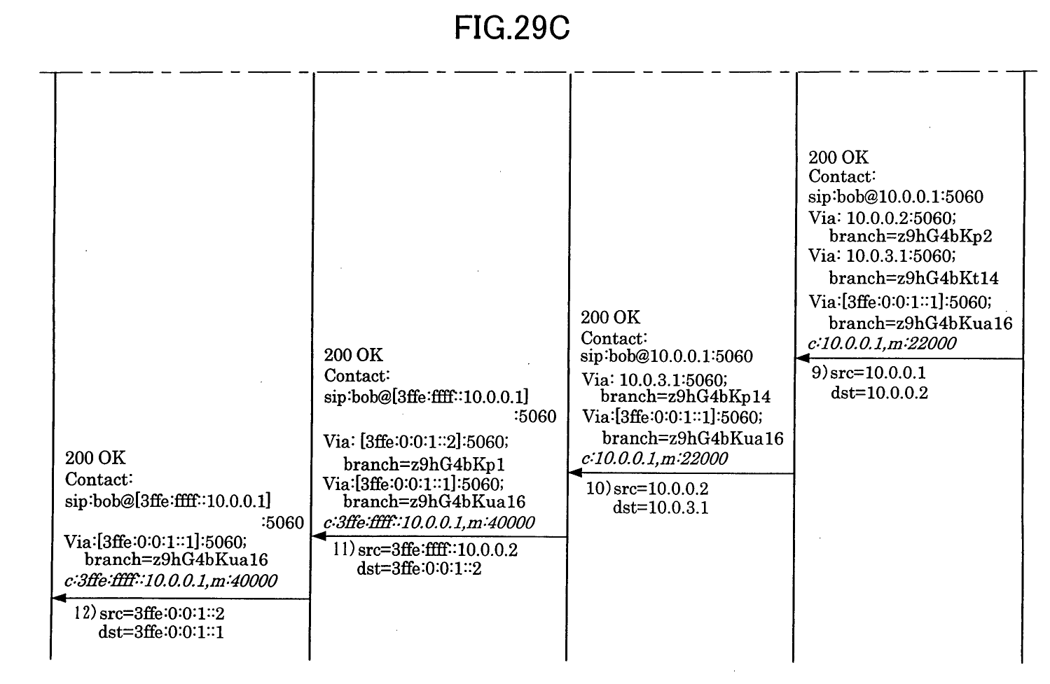

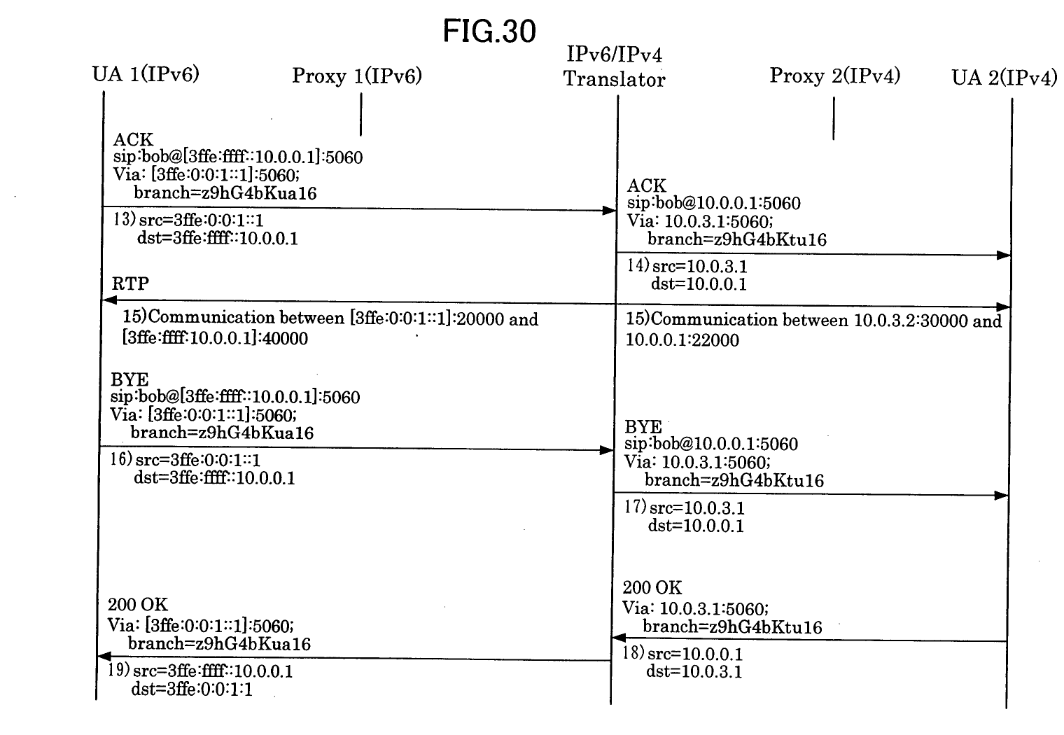

FIG. 28 is a conceptual example diagram for communication from a terminal UA1 “alice” to a terminal UA2 “bob”. FIGS. 29 and 30 are operational diagrams of FIG. 28.
1) UA1 sends an INVITE message to UA2. Since UA1 has been set to use SIP Proxy1, the destination address of this packet is the IPv6 address of SIP Proxy1.
2) SIP Proxy1 adds its own address to the Via field of packet 1) and forwards the packet to Proxy2. The destination of the packet then is an IPv6 address which is generated from an IPv4 address of SIP Proxy2 and a dummy prefix.
3) The packet which has a dummy prefix for destination is delivered to an IPv6/IPv4 translator. The IPv6/IPv4 translator translates packet 2) from IPv6 to IPv4. At the same time, the IPv6/IPv4 translator changes the Via field and the Contact field of the INVITE message into an address for SIP translation (which is 10.0.3.1 here) which has been set to the IPv6/IPv4 translator itself. Moreover, in order to translate media data (in the case of VoIP, voice data), the IPv6/IPv4 translator translates the Connection Information field (c) and the Media Description, name and address field (m) of an SDP message into an address (which is 10.0.3.2 here), which has been set for RTP translation in the IPv6/IPv4 translator, and an arbitrary port (which is port 30000 here).
4) SIP Proxy2 adds its own address to the Via field of the received SIP message and forwards the packet to UA2.
5) UA2 sends a 180 Ringing message to Proxy2.
6) SIP Proxy2 deletes the Via field that SIP Proxy2 itself added after receiving packet 5), and forwards the packet to SIP Proxy1. The destination of this packet is an address for SIP translation which has been set to the IPv6/IPv4 translator itself.
7) The packet which has an address for SIP translation for destination is delivered to the IPv6/IPv4 translator. The IPv6/IPv4 translator translates the packet from IPv4 to IPv6. At the same time, the IPv6/IPv4 translator translates an address of the Contact field to an IPv6 address which is generated from a dummy prefix and an address of UA2. The IPv6/IPv4 translator restores the Via field of packet 6) consistent with the branch of the Via field, which was included when the IPv6/IPv4 translator translated from packet 2) into packet 3).
8) SIP Proxy1 which received packet 7) deletes the Via field that SIP Proxy1 itself added, and forwards the packet to UA1.
9) When communication has become enabled in UA2 (in the case of a telephone, when its receiver is picked up), a “200 OK” message is sent to UA1. The destination address of this packet is an IPv4 address of SIP Proxy2.
10) SIP Proxy2 deletes the Via field, which SIP Proxy2 itself added, from packet 9), and forwards the packet to SIP Proxy1. The destination address of this packet is an address for SIP translation (10.0.3.1) which has been set to the IPv6/IPv4 translator itself.
11) The IPv6/IPv4 translator translates packet 10) and sends the packet to SIP Proxy1. As in the case of 4), the IPv6/IPv4 translator changes the Via field and the Contact field to an IPv6 address, which is generated from an IPv4 address of UA2 and a dummy prefix. The IPv6/IPv4 translator restores the Via field of packet 10) consistent with the branch of the Via field, which was included when the IPv6/IPv4 translator translated packet 2) into packet 3). Moreover, in order to translate media data, the IPv6/IPv4 translator translates the Connection Information field (c) of an SDP message into an IPv6 address, which is generated from an IPv4 address and a dummy prefix, and also changes the Media Description, name and address field (m) into an arbitrary port (which is port 40000 here).
12) SIP Proxy1 deletes the Via field that SIP Proxy1 itself added, and forwards the message to UA1.
13) UA1 sends an ACK message. The Request-URI of this message and the destination of the packet are determined on the basis of the Contact field of packet 12).
14) The IPv6/IPv4 translator translates packet 13) and sends the packet to UA2. The Request-URI field of packet 13) has been generated on the basis of the Contact field of packet 12). Since this Contact field has been changed by the IPv6/IPv4 translator when packet 10) was translated into packet 13), the IPv6/IPv4 translator restores the Request-URI field to the same field as the Contact field of packet 10).
15) Data communication between UA1 and UA2 starts via the IPv6/IPv4 translator. Information such as respective destinations, ports, and so on is then determined on the basis of the Connection Information field (c) and the Media Description, name and address field (m) of the messages which were exchanged in the above steps 1) to 8).
16) UA1 sends a BYE message. The Request-URI of the message and the destination of the packet are determined on the basis of the Contact field of packet 12).
17) The packet which has a dummy prefix for destination is delivered to the IPv6/IPv4 translator. The IPv6/IPv4 translator translates packet 16) in the same manner as in the case of translating packet 13) into packet 14), and sends the packet to UA2.
18) After receiving BYE, UA2 sends a “200 OK” to UA1.
19) The IPv6/IPv4 translator translates packet 18) and sends the packet to UA1.

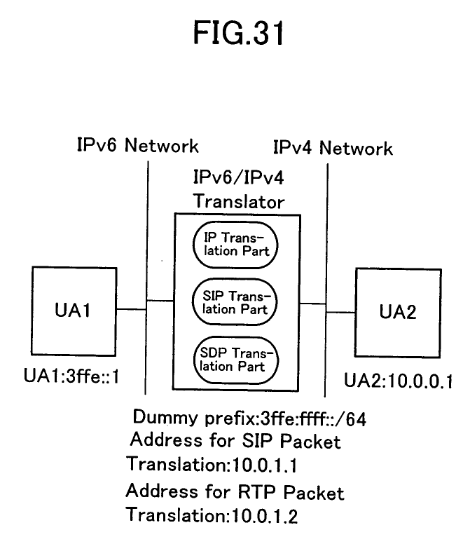

FIG. 31 illustrates that addresses are provided to elements of FIG. 15 wherein an IPv6/IPv4 translator is connected between UA1 and UA2 to perform communication without going through SIP Proxy. In FIG. 31, a unique IPv6 prefix called “dummy prefix” is preset to the IPv6/IPv4 translator for mapping IPv4 addresses to IPv6 addresses. Moreover, UA1 and UA2 are preset so that they can use the IPv6/IPv4 translator. Addresses of terminals in FIG. 31 are as follows:
UA1 (IPv6): 3ffe::1
UA2 (IPv4): 10.0.0.1
IPv6 address of UA2 with a dummy prefix: 3ffe:ffff::10.0.0.1
Dummy prefix: 3ffe:ffff::/64
IPv4 address for SIP packet translation: 10.0.1.1
IPv4 address for RTP packet translation: 10.0.1.2

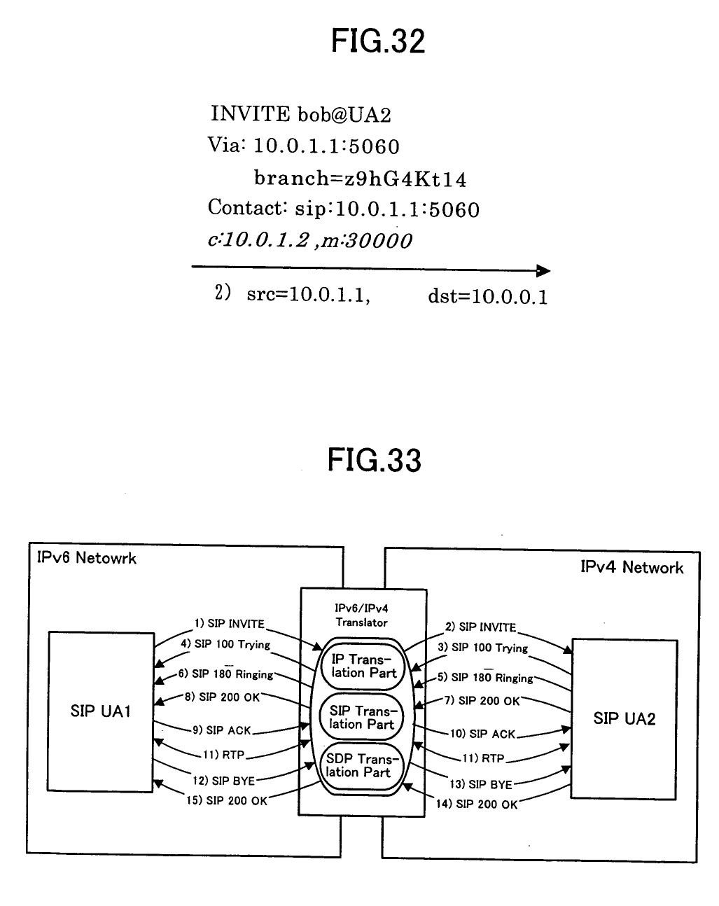

FIG. 32 shows an SIP message that UA1 and UA2 use for communications. In FIG. 32, the SIP message represents necessary elements only. The italicized element represents an SDP message. The highlighted characters mean that they were translated by an IPv6/IPv4 translator. “src” and “dst” that follow a number represent the source address and the destination address of the packet.

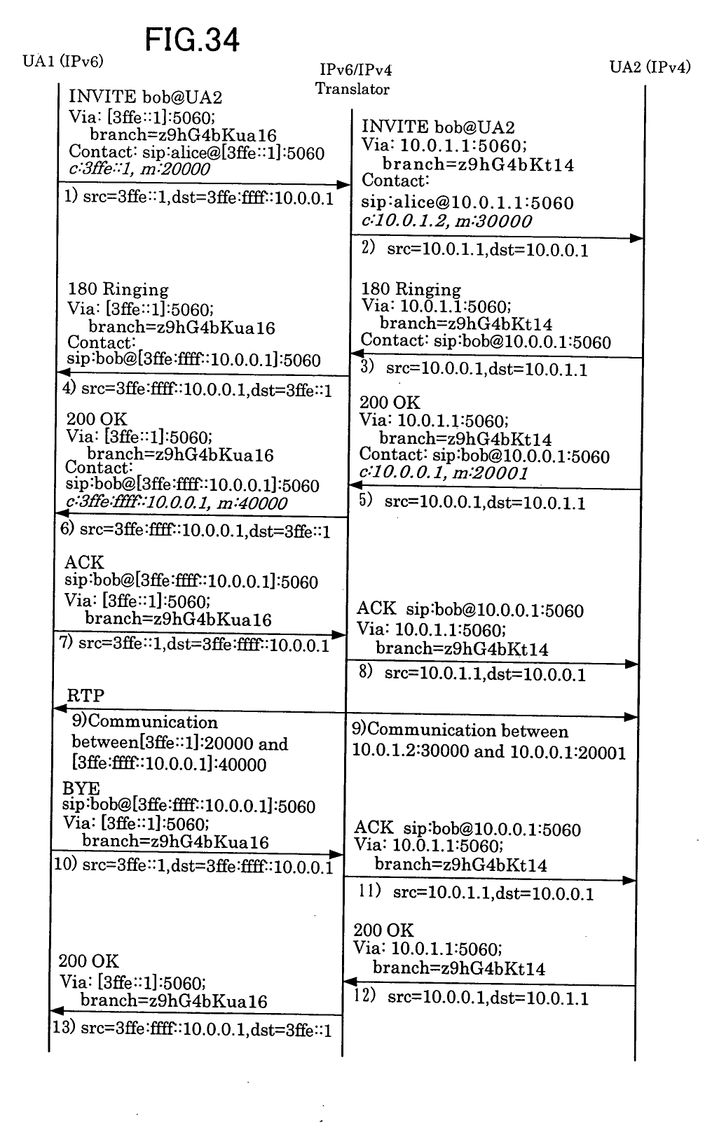

FIG. 33 is a conceptual example diagram for communications from a terminal UA1 “alice” to a terminal UA2 “bob”. FIG. 34 is the operational diagram of FIG. 33.
1) UA1 sends an INVITE message to UA2. The destination address of this packet is an IPv6 address which is generated from an IPv4 address of UA2 and a dummy prefix.
2) The packet which has a dummy prefix for destination is delivered to an IPv6/IPv4 translator. The IPv6/IPv4 translator translates the packet from IPv6 to IPv4. At the same time, the IPv6/IPv4 translator changes addresses of the Via and Contact fields of the INVITE message into an address for translation (which is 10.0.1.1 here) which has been set to the IPv6/IPv4 translator itself. Moreover, the IPv6/IPv4 translator reconfigures the branch of the Via field. Furthermore, in order to translate media data (in the case of VoIP, voice data), the IPv6/IPv4 translator changes the Connection Information field (c) and the Media Description, name and address field (m) of an SDP message into an address (10.0.1.2), which has been set for RTP translation in the IPv6/IPv4 translator, and an arbitrary port (which is port 20001 here).
3) After receiving packet 2), UA2 sends a 180 Ringing message.
4) The IPv6/IPv4 translator translates packet 3) and sends the packet to UA1.
5) When communication has become enabled in UA2 (in the case of a telephone, when its receiver is picked up), a 200 OK message is sent to UA1.
6) The IPv6/IPv4 translator translates packet 5) and sends the packet to UA1. The IPv6/IPv4 translator changes the address of the Contact field of this message into an IPv6 address, which is generated from a dummy prefix and an IPv4 address of UA2. The IPv6/IPv4 translator restores the Via field of packet 5) consistent with the branch of the Via field which was included when the IPv6/IPv4 translator translated packet 1) into packet 2). Moreover, in order to translate media data , the IPv6/IPv4 translator changes the Connection Information field (c) and the Media Description, name and address field (m) of the SDP message into an IPv6 address, which is generated from a dummy prefix and an IPv4 address of UA2, and an arbitrary port (which is 40000 here).
7) UA1 sends an ACK message. The source and Request-URI of this message are determined on the basis of the Contact field of the SIP message which was received in step 6).
8) The IPv6/IPv4 translator translates packet 7) and sends the packet to UA2. The Request-URI field of packet 7) has been generated on the basis of the Contact field of packet 6). Since this Contact field was changed by the IPv6/IPv4 translator when packet 5) was translated into packet 6), the IPv6/IPv4 translator restores the Request-URI field to the same field as the Contact field of packet 5).
9) RTP communication starts between UA1 and UA2 via the IPv6/IPv4 translator. Information such as respective destinations, ports, and so on is then determined on the basis of the Connection Information field (c) and the Media Description, name and address field (m) of the messages which were exchanged in the above steps 1), 2), 7), and 8).
10) UA1 sends a BYE message. The destination address and Request-URI of this packet are determined on the basis of the Contact field of the SIP message, which was received in the above step 6).
11) The IPv6/IPv4 translator translates packet 10) and sends the packet to UA2.
12) UA2 sends a 200 OK message.
13) The IPv6/IPv4 translator translates packet 12) and sends the packet to UA2.

Accordingly, an IPv6/IPv4 translator based on the present invention enables communication between terminals which support different protocols only, and is suitable for various media data transmissions including IP phone services.

1. An IPv6/IPv4 translator for translating packets between IPv6 and IPv4, wherein means of translating addresses described in SIP messages into IPv6 addresses or IPv4 addresses is provided.

2. The IPv6/IPv4 translator of claim 1, wherein means of translating addresses described in SDP messages into IPv6 addresses or IPv4 addresses is provided.

3. The IPv6/IPv4 translator of claim 2, wherein said SDP messages are related to media data transmissions.

4. The IPv6/IPv4 translator of any of claims 1 to 3, wherein said IPv6/IPv4 translator is directly connected to a terminal connected to an IPv6 network and to a terminal connected to an IPv4 network.

5. The IPv6/IPv4 translator of any of claims 1 to 3, wherein said IPv6/IPv4 translator is connected via SIP Proxy to an SIP terminal connected to an IPv6 network and to an SIP terminal connected to an IPv4 network.
